(19) United States
(12) Patent Application Publication
(10) Pub. No.: US 2017/0353701 A1
(43) Pub. Date: Dec. 7, 2017

(54) LIGHT SOURCE APPARATUS AND PROJECTOR

(71) Applicant: SEIKO EPSON CORPORATION, Tokyo (JP)

(72) Inventor: Akira EGAWA, Shiojiri-Shi (JP)

(73) Assignee: SEIKO EPSON CORPORATION, Tokyo (JP)

(21) Appl. No.: 15/608,040

(22) Filed: May 30, 2017

(30) Foreign Application Priority Data
Jun. 1, 2016 (JP) 2016-110427
Jun. 1, 2016 (JP) 2016-110428

(51) Int. Cl. H04N 9/31

(52) U.S. Cl. CPC H04N 9/3144; H04N 9/3158

(57) ABSTRACT

A light source apparatus includes a light source, an optical element on which light emitted from the light source is incident, and a rotating device that rotates the optical element. The optical element includes a substrate rotated by the rotating device, an optical element layer located on a first surface of the substrate, and a heat dissipater located on the substrate. The heat dissipater has a plurality of fins extending from the side facing the center of rotation of the optical element toward the outer circumference of the optical element and arranged along the rotational direction. Among the plurality of fins, the dimension along the rotational direction between two fins adjacent to each other in the rotational direction is so set as to fall within a predetermined dimension range.

### BACKGROUND

### 1. Technical Field

The present invention relates to a light source apparatus and a projector.

### 2. Related Art

There is a known projector of related art including a light source apparatus, a light modulator that modulates light outputted from the light source apparatus to form an image according to image information, and a projection optical apparatus that enlarges and projects the formed image on a projection surface, such as a screen. As a projector of this type, there is a known projector including a light source apparatus including semiconductor lasers and a reflective color wheel (see Japanese Patent No. 5,429,079, for example).

In the projector described in Japanese Patent No. 5,429,079, the reflective color wheel has a base rotated with a motor as a rotating mechanism, and the base has one surface that is so processed as to have a mirror surface and divided into a plurality of segments at 2-degrees rotational angular intervals. Phosphor layers that emit red light, green light, and blue light when excited with excitation light fluxes incident from the semiconductor lasers are sequentially formed on the segments along the rotational direction of the base. When the thus configured base is rotated, and the phosphor layers, on which the excitation light fluxes are incident, are sequentially switched from one to another, the color light fluxes are sequentially outputted.

The phosphor layers on the reflective color wheel generate heat when the excitation light fluxes are incident thereon, and when the phosphor layers are heated to too high a temperature, the efficiency of conversion of the wavelength of the excitation light decreases. To avoid the situation, the reflective color wheel has a plurality of fins, which function as a heat dissipater, formed on and integrated with the rear surface of the base. Examples of the fins may include a plurality of fins concentrically formed around the center of rotation of the base and a plurality of fins radially formed from the side facing the center of rotation. Still another example of the fins is a plurality of fins helically formed around the center of rotation.

In general, a plurality of fins located on a rotating optical element, such as the reflective color wheel, are radially or helically formed so that a cooling gas having cooled the fins is readily discharged toward the outer circumference of the base.

However, when the plurality of fins are, for example, densely arranged so that the inter-fin dimension is inappropriate, the cooling air having cooled the fins are unlikely to be discharged from the side facing the center of rotation of the base toward the outer circumference thereof, undesirably resulting in a decrease in cooling efficiency.

Further, the life of an optical element having a plurality of fins, such as the reflective color wheel described in Japanese Patent No. 5,429,079, depends on how well the generated heat is dissipated, in other words, how high the efficiency of cooling of the optical element.

A structure for efficiently cooling an optical element has therefore been desired.

### SUMMARY

An advantage of some aspects of the invention is to provide a light source apparatus that allows improvement in efficiency of cooling of an optical element, and another advantage of some aspects of the invention is to provide a projector.

A light source apparatus according to a first aspect of the invention includes a light source, an optical element on which light emitted from the light source is incident, and a rotating device that rotates the optical element. The optical element includes a substrate rotated by the rotating device, an optical element layer located on a first surface of the substrate and disposed inside an outer edge of the substrate and along a rotational direction of the substrate, with the light emitted from the light source being incident on the first surface, and a heat dissipater located on at least one of the first surface and a second surface opposite the first surface. The heat dissipater has a plurality of fins extending from a side facing a center of rotation of the optical element toward an outer circumference of the optical element and arranged along the rotational direction. Among the plurality of fins, a dimension along the rotational direction between two fins adjacent to each other in the rotational direction is so set as to fall within a predetermined dimension range.

A wavelength conversion element having, as the optical element layer, a wavelength conversion layer (phosphor layer, for example) that converts the wavelength of light incident on the layer and a diffusion element having, as the optical element layer, a diffusion layer that diffuses light incident on the layer can be exemplified as the optical element.

According to the first aspect, the dimension along the rotational direction of the optical element between two fins adjacent to each other in the rotational direction (that is, inter-fin channel width along the direction perpendicular, in a plan view, to the extension direction of a channel of a cooling gas flowing through the space between the fins) is so set as to fall within a predetermined dimension range. Therefore, in a portion where the channel width is so set as to fall within the dimension range, the fins can readily produce vortices of the cooling gas (vortices having an axis of rotation along the extension direction of the fins) when the optical element rotates, and the produced vortices are allowed to be likely to collide with the facing end surfaces of the two adjacent fins. As a result, the cooling gas is allowed to effectively collide with the fins, whereby heat in the fins can be readily transferred to the cooling gas. Therefore, heat generated in the optical element layer can be efficiently cooled, whereby the efficiency of cooling of the optical element can be improved. In addition, since the optical element is stabilized, a light source apparatus capable of stably outputting light can be configured.

In the first aspect, it is preferable that the dimension along the rotational direction between the adjacent two fins is so set as to fall within the dimension range at least in a portion on a side facing the outer circumference of the optical element layer.

In a case where heat is generated in the optical element layer, the heat is transferred from the optical element layer to the substrate and then transferred to an inner circumferential area (area facing center of rotation) of the substrate, which is the area inside the inner circumference of the optical element layer, and an outer circumferential area of the substrate, which is the area outside the outer circumference of the optical element layer. When the optical element is rotated, since the flow speed of the cooling gas flowing through the outer circumferential area is greater than the flow speed of the cooling gas flowing through the inner circumferential area, the outer circumferential area of the substrate is more likely to be cooled than the inner circumferential area of the substrate, and the heat described above is also more likely to be transferred to the outer circumferential area than to the inner circumferential area.

In view of the fact described above, according to the first aspect, at least in the portion outside the outer circumference of the optical element layer (outer circumferential area), the channel width is so set as to fall within the dimension range, whereby the efficiency of cooling of the portion outside the outer circumference can be reliably improved. The efficiency of cooling of the optical element can therefore be reliably improved as compared with a case where the area where the channel width is so set as to fall within the dimension range is only the inner circumferential area, which is the area inside the inner circumference of the optical element layer.

In the first aspect, it is preferable that the dimension along the rotational direction between the adjacent two fins is so set as to fall within the dimension range over a range from the center of rotation to an outer circumference of the substrate.

According to the configuration described above, the channel width is so set as to fall within the dimension range in the inner circumferential area and the outer circumferential area. The heat can therefore be further readily transferred from the fins to the cooling gas as compared with a case where the channel width is so set as to fall within the dimension range only in the outer circumferential area. The efficiency of cooling of the optical element can therefore be more reliably improved.

In the first aspect, it is preferable that the dimension range is set in accordance with a size of vortices of a cooling gas that are formed by the plurality of fins when the optical element rotates.

In a case where the channel width is relatively narrow, for example, in a case where the channel width is smaller than the size of the vortices, the vortices are unlikely to be produced even when the optical element is rotated. On the other hand, in a case where the channel width is significantly greater than the size of the vortices, the vortices, even when they are produced in the spaces between the fins, are unlikely to collide with the fins located on the side facing opposite the rotational direction, and the cooling efficiency is therefore not very high.

In contrast, according to the configuration described above, in which the dimension range is set in accordance with the size of the vortices, the dimension range can be so set that each of the produced vortices collides with the two fins that sandwich the vortex. Further, when the channel width is so set as to fall within the thus set dimension range, the efficiency of cooling of the optical element can be reliably improved.

In the first aspect, it is preferable that the dimension range is greater than or equal to 3 mm and smaller than or equal to 6 mm.

According to the configuration described above, not only can the vortices be reliably produced in the spaces between the plurality of fins when the optical element rotates, but also each of the vortices is allowed to reliably collide with the two fins that sandwich the vortex. The efficiency of cooling of the optical element can therefore be reliably improved.

In the first aspect, it is preferable that a dimension of the plurality of fins in a direction along an axis of rotation of the optical element is at least 3 mm.

In a case where the optical element is rotated at a rotational speed, for example, greater than or equal to 3000 rpm and smaller than or equal to 9000 rpm, and when the dimension of the fins in the direction along the axis of rotation (standing dimension of fins measured from substrate) is smaller than 3 mm, the vortices are likely to collide with the bottom surface of the substrate (surface from fins stand), so that the vortices are unlikely to be continuously produced.

In contrast, when the dimension of the fins is at least 3 mm, the vortices are unlikely to collide with the bottom surface of the substrate, so that the vortices are likely to be continuously produced. The efficiency of cooling of the optical element can therefore be more reliably improved.

In the first aspect, it is preferable that the plurality of fins include a plurality of first fins arranged along the rotational direction and a plurality of second fins that are each disposed between two first fins adjacent to each other among the plurality of first fins and are arranged along the rotational direction, that an end of each of the plurality of first fins that faces the center of rotation is located on a first virtual circle a center of which coincides with the center of rotation and which has a predetermined diameter, that an end of each of the plurality of first fins that faces the outer circumference is located on a second virtual circle a center of which coincides with the center of rotation and which has a diameter greater than the diameter of the first virtual circle, that an end of each of the plurality of second fins that faces the center of rotation is located on a third virtual circle a center of which coincides with the center of rotation and which has a diameter greater than the diameter of the first virtual circle and smaller than the diameter of the second virtual circle, that an end of each of the plurality of second fins that faces the outer circumference is located on the second virtual circle, and that among the plurality of first fins and the plurality of second fins, a dimension along the rotational direction between a first fin and a second fins adjacent to each other in the rotational direction is so set as to fall within the dimension range.

In a case where the fins so configured that the dimension (channel width) is so set as to fall within the dimension range are densely formed on the substrate in a cutting process, the dimension between the fins on the side facing the center of rotation could undesirably exceed the dimension range depending on the size of a cutting tool.

In contrast, the second fins, which are smaller than the first fins, are so provided as to be located in the area outside the outer circumference of the first virtual circle and between the first fins, whereby the above-mentioned dimension between the first fins is readily so set as to fall within the dimension range over the area from the first virtual circle to the third virtual circle, and the dimension between the first fins and the second fins is readily so set as to fall within the dimension range over the area from the third virtual circle to the second virtual circle. Therefore, not only can the fins so configured that the channel width is set as described above be reliably formed in a cutting process, but also an optical element having improved cooling efficiency can be reliably configured.

In the first aspect, it is preferable that an intersection angle between a line tangent to an edge of each of the fins that faces in the rotational direction and a radial direction originating from the center of rotation is so set as to fall within an angular range greater than or equal to −45° and smaller than or equal to +60°.

A case where the intersection angle is 0° represents that each of the fins is perpendicular, in a position where the tangent is specified, to the rotational direction of the substrate. In a case where the intersection angle is negative (has negative value), each of the fins has a shape that, for example, warps toward the side facing in the rotational direction with distance from the side facing the center of rotation toward the outer circumference, whereas in a case where the intersection angle is positive (has positive value), each of the fins has a shape that, for example, warps toward the side facing opposite the rotational direction with distance from the side facing the center of rotation toward the outer circumference.

The heat transfer coefficient representing heat transfer from the fins to the cooling gas flowing toward the outer circumference changes in accordance with the intersection angle. For example, when the intersection angle is a value outside the angular range, the fins are likely to follow the rotational direction, and vortices are unlikely to be produced, resulting in a decrease in the effect.

In contrast, according to the configuration described above, in which the intersection angle is so set as to fall within the angular range, vortices are likely to be produced, whereby the efficiency of cooling of the optical element can be reliably improved.

The angular range is preferably greater than 0° and smaller than or equal to +60°.

In the case where the intersection angle is negative (has negative value), so that the fin has a shape that warps toward the side facing in the rotational direction with distance from the side facing the center of rotation toward the outer circumference, and when the optical element is rotated, pressure that causes the cooling gas to flow from the side facing the outer circumference toward the center of rotation is produced. In this case, the cooling gas is likely to stay between the fins, and the efficiency of cooling of the optical element therefore decreases.

On the other hand, in the case where the intersection angle is 0°, so that the fin is perpendicular to the rotational direction of the substrate, the rotational resistance (air resistance) of the optical element increases, and the load acting on the rotating device therefore increases.

In contrast, when the angular range is greater than 0° and smaller than or equal to +60°, the problems described above are solved, whereby an optical element having further improved cooling efficiency can be configured.

A light source apparatus according a second aspect of the invention includes a light source, an optical element on which light emitted from the light source is incident, and a rotating device that rotates the optical element. The optical element includes a substrate rotated by the rotating device, an optical element layer located on a first surface of the substrate and disposed inside an outer edge of the substrate and along a rotational direction of the substrate, with the light emitted from the light source being incident on the first surface, and a heat dissipater located on at least one of the first surface and a second surface opposite the first surface. The heat dissipater has a plurality of fins extending from a side facing a center of rotation of the optical element toward an outer circumference of the optical element and arranged along the rotational direction. An intersection angle between a line tangent to an edge of each of the plurality fins that faces opposite the rotational direction and a radial direction originating from the center of rotation is so set as to fall within a predetermined angular range.

A wavelength conversion element having, as the optical element layer, a wavelength conversion layer that converts the wavelength of light incident on the layer and a diffusion element having, as the optical element layer, a diffusion layer that diffuses light incident on the layer can be exemplified as the optical element.

According to the second aspect, in which the intersection angle of each of the fins is so set as to fall within the predetermined angular range, when the optical element is rotated, a vortex of the cooling gas is likely to be produced in the space between two fins adjacent to each other in the rotational direction of the optical element. The vortex collides with the facing end surfaces of the two fins (end surface of the rotational-direction-side fin that faces opposite the rotational direction and rotational-direction-side end surface of the fin facing opposite the rotational direction), whereby heat transfer from the fins to the cooling gas can be facilitated. The efficiency of cooling of the fins to which heat generated in the optical element layer is transferred via the substrate and hence the efficiency of cooling of the optical element can therefore be improved. As a result, the life of the optical element can be prolonged.

In the second aspect, it is preferable that each of the plurality of fins has a radius of curvature that changes with a position thereon.

According to the configuration described above, the above-mentioned intersection angle of part or entirety of the fins can be readily so set as to fall within the angular range. Therefore, in a portion where the intersection angle is so set as to fall within the angular range, the vortices are likely to be produced between the fins, whereby improvement in the efficiency of cooling of the optical element and extension of the life of the optical element can be reliably achieved.

In the second aspect, it is preferable that each of the plurality of fins is formed in an arcuate shape having the radius of curvature that increases with distance from the side facing the center of rotation toward the outer circumference.

According to the configuration described above, the intersection angle can be readily so set as to fall within the angular range across the entire fins. Therefore, since the vortices can be readily produced over the entire spaces between the fins, the improvement in the efficiency of cooling of the optical element and the extension of the life of the optical element can be more reliably achieved than in a case where the vortices are produced in part of the spaces between the fins.

In the second aspect, it is preferable that the angular range is greater than or equal to −45° and smaller than or equal to +60°.

According to the configuration described above, since the fins can face in the rotational direction of the optical element, the vortices can be more readily formed on the side of each of the fins that faces opposite the rotational direction when the optical element rotates. The improvement in the efficiency of cooling of the optical element and the extension of the life of the optical element can therefore be more reliably achieved.

In the second aspect, it is preferable that the angular range is greater than 0° and smaller than or equal to +60°.

In the case where the above-mentioned intersection angle of each of the fins is 0°, that is, in the case of the fins that radially extend from the side facing the center of rotation, the load acting on the rotating device, which rotates the optical element, increases because the fins are perpendicular to the rotational direction and the air resistance (rotational resistance) therefore increases.

On the other hand, the fins having the intersection angle greater than or equal to −45° and smaller than 0° each have a shape that warps toward the side facing in the rotational direction with distance from the side facing the center of rotation toward the outer circumference of the substrate. When the fins have the shape, and the optical element is rotated, pressure that causes the cooling gas to flow from the side facing the outer circumference toward the center of rotation is produced. In this case, the cooling gas flowing from the side facing the center of rotation toward the outer circumference is likely to stay between the fins, and the efficiency of cooling of the optical element therefore decreases.

In contrast, according to the configuration described above, the cooling gas flowing through the spaces between the fins is likely to flow from the side facing the center of rotation toward the outer circumference, whereby the flow speed and flow rate of the cooling gas can be increased. Therefore, since the situation in which the cooling gas to which the heat is transferred from the fins stays in the spaces between the fins can be avoided, the efficiency of cooling of the optical element can be further improved.

In the second aspect, it is preferable that, among the plurality of fins, a dimension along the rotational direction between two fins adjacent to each other in the rotational direction of the optical element is so set as to fall within a predetermined dimension range.

In the case where the dimension, that is, the width of the channel of the cooling gas flowing through the spaces between the fins is relatively narrow, for example, in a case where the channel width is smaller than the size of the vortices, the vortices are unlikely to be produced in the spaces between the fins even when the optical element is rotated. On the other hand, in the case where the channel width is significantly greater than the size of the vortices, the vortices, even when they are produced in the spaces between the fins, are unlikely to collide with the fins located on the side facing opposite the rotational direction (in detail, rotational-direction-side end surfaces of fins), and the cooling efficiency is therefore not very high.

In contrast, according to the configuration described above, in which the dimension along the rotational direction between the two fins is so set as to fall within the dimension range set in accordance, for example, with the size of the vortices, each of the produced vortices is allowed to collide with a fin on the rotational direction side and a fin adjacent to the rotational-direction-side fin and facing opposite the rotational direction. The efficiency of cooling of the optical element can therefore be more reliably improved.

In the second aspect, it is preferable that the dimension range is greater than or equal to 3 mm and smaller than or equal to 6 mm.

According to the configuration described above, not only can the vortices be reliably produced in the spaces between the plurality of fins when the optical element rotates, but also each of the vortices is allowed to reliably collide with a fin on the rotational direction side and a fin adjacent to the rotational-direction-side fin and facing opposite the rotational direction. The efficiency of cooling of the optical element can therefore be reliably improved.

A projector according to a third aspect of the invention includes any of the light source apparatus described above, a light modulator that modulates light outputted from the light source apparatus, and a projection optical apparatus that projects the light modulated by the light modulator.

According to the third aspect, the same effects provided by the light source apparatus according to the first and second aspects can be provided. In addition, since the light source apparatus can stably output light, a reliable projector can be configured.

### BRIEF DESCRIPTION OF THE DRAWINGS

The invention will be described with reference to the accompanying drawings, wherein like numbers reference like elements.

FIG. 1 is a perspective view showing an exterior appearance of a projector according to a first embodiment of the invention.

FIG. 2 is a diagrammatic view showing the configuration of an apparatus body in the first embodiment.

FIG. 3 is a diagrammatic view showing the configuration of an illuminator in the first embodiment.

FIG. 4 is a perspective view of a wavelength conversion element viewed from the side opposite the light incident side in the first embodiment.

FIG. 5 is a diagrammatic view showing vortices produced by fins in the first embodiment.

FIG. 6 shows graphs illustrating the relationship between a channel width and a heat transfer coefficient for each rotational speed in the first embodiment.

FIG. 7 is a perspective view of the wavelength conversion element viewed from the light incident side in the first embodiment.

FIG. 8 is a perspective view of a wavelength conversion element provided in a light source apparatus of a projector according to a second embodiment of the invention and viewed from the side opposite the light incident side.

FIG. 9 is a plan view of the wavelength conversion element in the second embodiment viewed from the side opposite the light incident side.

FIG. 10 shows a graph illustrating the relationship between a channel width and a heat transfer coefficient ratio in the second embodiment.

FIG. 11 is a perspective view of a wavelength conversion element provided in a light source apparatus of a projector according to a third embodiment of the invention and viewed from the side opposite the light incident side.

FIG. 12 is a plan view of the wavelength conversion element in the third embodiment viewed from the side opposite the light incident side.

FIG. 13 is a perspective view of a wavelength conversion element provided in a light source apparatus of a projector according to a fourth embodiment of the invention and viewed from the side opposite the light incident side.

FIG. 14 is a plan view of the wavelength conversion element in the fourth embodiment viewed from the side opposite the light incident side.

FIG. 15 describes the intersection angle between a tangent corresponding to the position on a fin's edge facing opposite the rotational direction of a substrate and the radial direction of the substrate in the fourth embodiment.

FIG. 16 is a plan view of a wavelength conversion element presented as a comparative example in the fourth embodiment and viewed from the side opposite the light incident side.

FIG. 17 shows graphs illustrating the relationship between the angle of the fins with respect to the radial direction (tangent intersection angle) and the heat transfer coefficient for each channel width in the fourth embodiment.

FIG. 18 shows graphs illustrating the relationship between the angle of the fins with respect to the radial direction (tangent intersection angle) and the heat transfer coefficient ratio for each channel width in the fourth embodiment.

### DESCRIPTION OF EXEMPLARY EMBODIMENTS

### First Embodiment

A first embodiment of the invention will be described below with reference to the drawings.

### Schematic Configuration of Projector

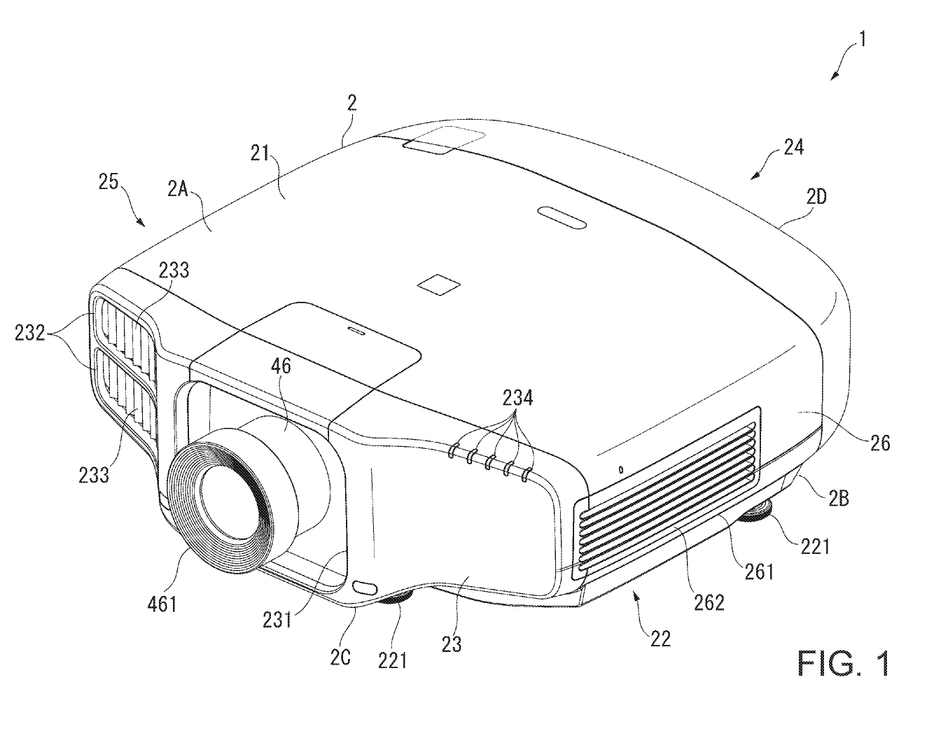

FIG. 1 is a perspective view showing an exterior appearance of a projector 1 according to the present embodiment.

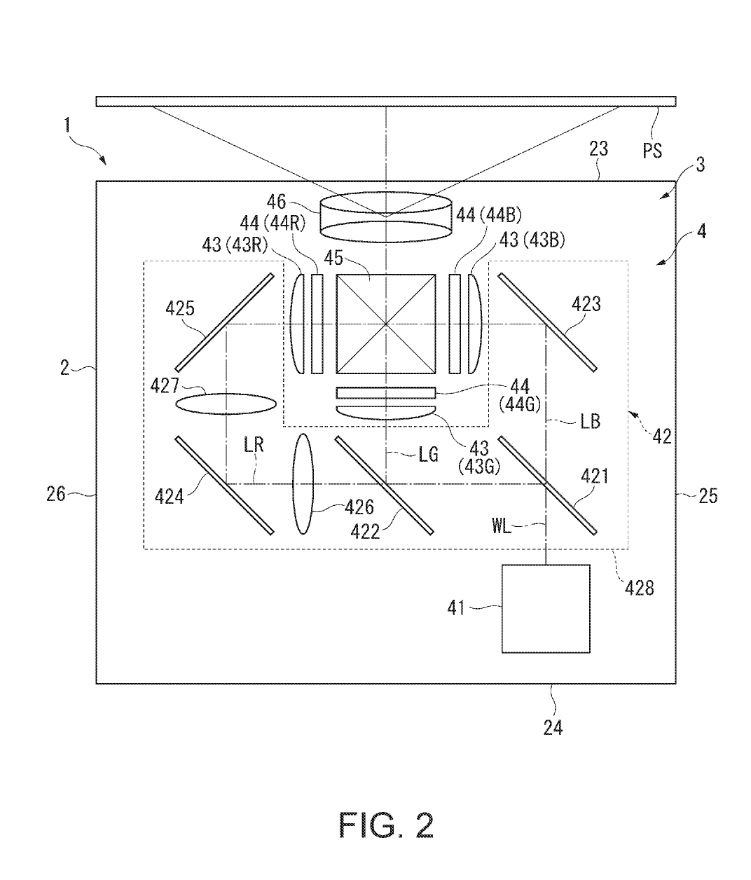

The projector 1 according to the present embodiment is a projection-type image display apparatus that modulates light outputted from a light source apparatus 5, which will be described later, to form an image according to image information and enlarges and projects the formed image on a projection surface PS, such as a screen. The projector 1 includes an exterior enclosure 2, which forms the exterior appearance of the projector 1, and an apparatus body 3 (see FIG. 2), which is accommodated and disposed in the exterior enclosure 2, as shown in FIG. 1.

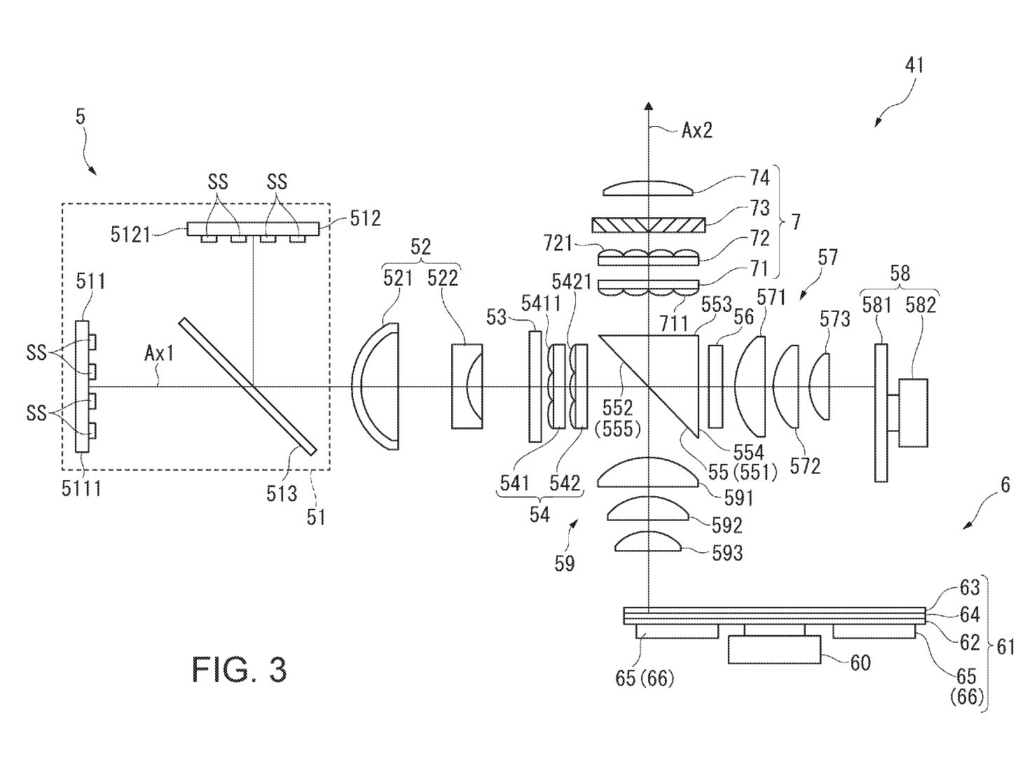

The thus configured projector 1, which will be described later in detail, is partly characterized in that a heat dissipater 65, which is part of a wavelength conversion element 61, which forms the light source apparatus 5 (see FIG. 3), has a plurality of fins 66, and that the width of channels of a cooling gas flowing through the spaces between the plurality of fins 66 is adequately set.

The configuration of the projector 1 will be described below.

### Configuration of Exterior Enclosure

The exterior enclosure 2 is formed of an upper case 2A, a lower case 2B, a front case 2C, and a rear case 2D, each of which is made of a synthetic resin and which are combined with one another into a roughly box-shaped shape, as shown in FIG. 1. The thus configured exterior enclosure 2 has a top surface section 21, a bottom surface section 22, a front surface section 23, a rear surface section 24, a left side surface section 25, and a right side surface section 26.

Legs 221 (FIG. 1 shows only two legs 221), which come into contact with an installation surface, in a case where the projector 1 is placed on the installation surface, are provided at a plurality of locations on the bottom surface section 22.

To expose an end portion 461 of a projection optical apparatus 46, which will be described later, an opening 231, through which an image projected by the projection optical apparatus 46 passes, is formed in a central portion of the front surface section 23.

Discharge ports 232, through which a heated cooling gas in the exterior enclosure 2 is discharged, are formed in the front surface section 23 and in positions shifted toward the left side surface section 25, and each of the discharge ports 232 is provided with a plurality of louvers 233.

On the other hand, a plurality of indicators 234, which indicate the action state of the projector 1, are provided on the front surface section 23 and in positions shifted toward the right side surface section 26.

An introduction port 261, through which outside air is introduced as the cooling gas into the exterior enclosure 2, is provided in the right side surface section 26, and a cover member 262, which is provided with a filter (not shown), is attached to the introduction port 261.

### Configuration of Apparatus Body

FIG. 2 is a diagrammatic view showing the configuration of the apparatus body 3.

The apparatus body 3 includes an image projection apparatus 4, as shown in FIG. 2. The apparatus body 3 further includes, although not shown, a controller that controls the action of the projector 1, a power supply that supplies electric parts that form the projector 1 with electric power, and a cooler that cools objects to be cooled.

### Configuration of Image Projection Apparatus

The image projection apparatus 4 forms an image according to an image signal inputted from the controller described above and projects the image on the projection surface PS. The image projection apparatus 4 includes an illuminator 41, a color separation apparatus 42, parallelizing lenses 43, light modulators 44, a color combiner 45, and the projection optical apparatus 46.

Among the components described above, the illuminator 41 outputs illumination light WL, which uniformly illuminates the light modulators 44. The configuration of the illuminator 41 will be described later in detail.

The color separation apparatus 42 separates the illumination light WL incident from the illuminator 41 into blue light LB, green light LG, and red light LR. The color separation apparatus 42 includes dichroic mirrors 421 and 422, reflection mirrors 423, 424, and 425, relay lenses 426 and 427, and an optical part enclosure 482, which accommodates the components described above.

The dichroic mirror 421 transmits the blue light LB contained in the illumination light WL described above and reflects the green light LG and the red light LR contained therein. The blue light LB having passed through the dichroic mirror 421 is reflected off the reflection mirror 423 and guided to the corresponding parallelizing lens 43 (43B).

The dichroic mirror 422 receives the green light LG and the red light LR reflected off the dichroic mirror 421 described above, reflects and guides the green light LG to the corresponding parallelizing lens 43 (43G), and transmits the red light LR. The red light LR is guided to the corresponding parallelizing lens 43 (43R) via the relay lens 426, the reflection mirror 424, the relay lens 427, and the reflection mirror 425.

Each of the parallelizing lenses 43 (reference characters 43R, 43G, and 43B denote parallelizing lenses for red, green, and blue color light fluxes, respectively) parallelizes the light incident thereon.

The light modulators 44 (reference characters 44R, 44G, and 44B denote light modulators for red, green, and blue color light fluxes, respectively) modulate the color light fluxes LR, LG, and LB described above having been parallelized and incident thereon to form images based on the color light fluxes LR, LG, and LB according to image signals inputted from the controller. Each of the light modulators 44 is formed, for example, of a liquid crystal panel that modulates a color light flux incident thereon and polarizers disposed on the light incident side and the light exiting side of the liquid crystal panel.

The color combiner 45 combines the images based on the color light fluxes LR, LG, and LB incident from the light modulators 44R, 44G, and 44B with one another. The color combiner 45 is formed of a cross dichroic prism in the present embodiment and can instead be formed of a plurality of dichroic mirrors.

The projection optical apparatus 46 enlarges and projects the combined image from the color combiner 45 on the projection surface PS. As the thus configured projection optical apparatus 46, for example, a lens unit formed of a lens barrel and a plurality of lenses disposed in the lens barrel can be employed.

### Configuration of Illuminator

FIG. 3 is a diagrammatic view showing the configuration of the illuminator 41.

The illuminator 41 outputs the illumination light WL toward the color separation apparatus 42, as described above. The illuminator 41 includes the light source apparatus 5 and a homogenizing apparatus 7, as shown in FIG. 3.

### Configuration of Light Source Apparatus

The light source apparatus 5 outputs a light flux to the homogenizing apparatus 7. The light source apparatus 5 includes a light source section 51, an afocal optical element 52, a first retardation element 53, a homogenizer optical apparatus 54, a light combiner 55, a second retardation element 56, a first light collecting element 57, a diffuser 58, a second light collecting element 59, and a wavelength converter 6.

Among the components described above, the light source section 51, the afocal optical element 52, the first retardation element 53, the homogenizer optical apparatus 54, the second retardation element 56, the first light collecting element 57, and the diffuser 58 are arranged along a first illumination optical axis Ax1. On the other hand, the second light collecting element 59 and the wavelength converter 6 are arranged along a second illumination optical axis Ax2 perpendicular to the first illumination optical axis Ax1. The light combiner 55 is disposed in the portion where the first illumination optical axis Ax1 and the second illumination optical axis Ax2 intersect each other.

### Configuration of Light Source Section

The light source section 51 is a light source that emits excitation light that is blue light toward the afocal optical element 52. The light source section 51 includes a first light source section 511, a second light source section 512, and a light combining member 513.

The first light source section 511 includes a solid-state light source array 5111, in which solid-state light sources SS, each of which is an LD (laser diode), are arranged in a matrix, and a plurality of parallelizing lenses (not shown) corresponding to the solid-state light sources SS. The second light source section 512 similarly includes a solid-state light source array 5121, in which solid-state light sources SS are arranged in a matrix, and a plurality of parallelizing lenses (not shown) corresponding to the solid-state light sources SS. The solid-state light sources SS emit excitation light fluxes, for example, having a peak wavelength of 440 nm but may instead emit excitation light fluxes having a peak wavelength of 446 nm. Still instead, each of the light source sections 511 and 512 may include both the solid-state light sources that emit excitation light fluxes having the peak wavelength of 440 nm and those that emit excitation light fluxes having the peak wavelength of 446 nm. The excitation light fluxes emitted from the solid-state light sources SS are parallelized by the parallelizing lenses and incident on the light combining member 513. In the present embodiment, the excitation light emitted from each of the solid-state light sources SS is S polarized light.

The light combining member 513 combines the excitation light fluxes with one another by transmitting the excitation light fluxes outputted from the first light source section 511 along the first illumination optical axis Ax1 and reflecting the excitation light fluxes outputted from the second light source section 512 along a direction that intersects the first illumination optical axis Ax1. In the present embodiment, the light combining member 513 is configured as a plate-shaped member in which a plurality of transmitters that transmit the excitation light fluxes from the first light source section 511 and a plurality of reflectors that reflect the excitation light fluxes from the second light source section 512 are alternately arranged. The excitation light fluxes having traveled via the thus configured light combining member 513 are incident on the afocal optical element 52.

### Configuration of Afocal Optical Element

The afocal optical element 52 adjusts the diameter of the excitation light incident from the light source section 51. Specifically, the afocal optical element 52 includes a lens 521, which causes the excitation light incident as parallelized light from the light source section 51 to converge so that the diameter of the excitation light decreases, and a lens 522, which parallelizes the excitation light incident through the lens 521 and outputs the parallelized excitation light.

### Configuration of First Retardation Element

The first retardation element 53 is a half-wave plate. That is, the S-polarized excitation light incident through the afocal optical element 52, when it passes through the first retardation element 53, is partially converted into P-polarized excitation light to form excitation light formed of S-polarized and P-polarized light and then incident on the homogenizer optical apparatus 54.

### Configuration of Homogenizer Optical Apparatus

The homogenizer optical apparatus 54 homogenizes, along with the first light collecting element 57 and the second light collecting element 59, the illuminance distribution of the excitation light to be incident on illumination areas of the diffuser 58 and the wavelength converter 6. The excitation light having passed through the homogenizer optical apparatus 54 is incident on the light combiner 55. The thus configured homogenizer optical apparatus 54 includes a first multi-lens 541 and a second multi-lens 542.

The first multi-lens 541 has a configuration in which a plurality of first lenses 5411 are arranged in a matrix in a plane perpendicular to the first illumination optical axis Ax1 and divides the excitation light incident on the first multi-lens 541 into a plurality of sub-light fluxes.

The second multi-lens 542 has a configuration in which a plurality of second lenses 5421, which correspond to the plurality of first lenses 5411 described above, are arranged in a matrix in a plane perpendicular to the first illumination optical axis Ax1. The second multi-lens 542, in cooperation with the first light collecting element 57 and the second light collecting element 59, superimposes the plurality of divided sub-light fluxes on one another in the illumination areas described above. The illuminance of the excitation light incident on the illumination areas is homogenized in a plane perpendicular to the center axis of the excitation light.

### Configuration of Light Combiner

The light combiner 55 is a PBS (polarizing beam splitter) formed of a prism 551, which is formed in the shape of a roughly right-angled isosceles triangular column, with a surface 552, which corresponds to the oblique side of the triangular shape, inclining by about 45° with respect to the first illumination optical axis Ax1 and the second illumination optical axis Ax2, a surface 553, which is one of the adjacent sides 553 and 554 of the triangular shape, being roughly perpendicular to the second illumination optical axis Ax2, and the surface 554, which is the other one of the adjacent sides, being roughly perpendicular to the first illumination optical axis Ax1. A polarization separation layer 555, which has wavelength selectivity, is formed on the surface 552.

The polarization separation layer 555 is characterized not only in that it separates the S polarized light and the P polarized light contained in the excitation light from each other but also in that it transmits fluorescence produced by the wavelength converter 6 irrespective of the polarization state of the fluorescence. That is, the polarization separation layer 555 has a wavelength-selective polarization separation characteristic as follows: The polarization separation layer 555 separates light having wavelengths within the blue light region into S polarized light and P polarized light and transmits both S polarized light and P polarized light contained in light having wavelengths within the green light region and the red light region.

The thus configured light combiner 55, which receives the excitation light incident through the homogenizer optical apparatus 54, transmits P polarized light out of the incident excitation light along the first illumination optical axis Ax1 toward the second retardation element 56 and reflects S polarized light out of the incident excitation light along the second illumination optical axis Ax2 toward the second light collecting element 59.

Although will be described later in detail, the light combiner 55 combines the excitation light incident via the second retardation element 56 (blue light) and the fluorescence incident via the second light collecting element 59 with each other.

### Configuration of Second Retardation Element

The second retardation element 56 is a quarter-wave plate, converts the P-polarized excitation light incident from the light combiner 55 into circularly polarized light, and converts the excitation light incident through the first light collecting element 57 (circularly polarized light having a polarization direction opposite the polarization direction of the initial circularly polarized light) into S polarized light.

### Configuration of First Light Collecting Element

The first light collecting element 57 is an optical element that collects the excitation light having passed through the second retardation element 56 (cause the excitation light to converge) on the diffuser 58 and is formed of three lenses 571 to 573 in the present embodiment. The number of lenses that form the first light collecting element 57 is, however, not limited to three.

### Diffuser

The diffuser 58 diffusively reflects the excitation light incident thereon in such a way that the reflected excitation light has the same diffusion angle as that of the fluorescence produced by and outputted from the wavelength converter 6. The diffuser 58 includes a disc-shaped diffusive reflection element 581, on which an annular reflection layer is formed around the center of rotation of the diffuser 58, and a rotating device 582, which rotates the diffusive reflection element 581. The reflection layer reflects light incident thereon in the Lambertian reflection scheme.

The excitation light diffusively reflected off the thus configured diffuser 58 is incident on the second retardation element 56 again via the first light collecting element 57. When reflected off the diffuser 58, the circularly polarized light incident on the diffuser 58 becomes circularly polarized light having a polarization direction opposite the polarization direction of the incident circularly polarized light and passes through the second retardation element 56, where the circularly polarized light is converted into S-polarized excitation light having a polarization direction rotated by 90° with respect to the polarization direction of the P-polarized excitation light incident from the light combiner 55. The resultant S-polarized excitation light is reflected off the polarization separation layer 555 described above and incident as the blue light along the second illumination optical axis Ax2 on the homogenizing apparatus 7.

### Configuration of Second Light Collecting Element

On the second light collecting element 59 is incident the S-polarized excitation light having passed through the homogenizer optical apparatus 54 and having been reflected off the polarization separation layer 555 described above. The second light collecting element 59 not only collects the excitation light incident thereon (causes excitation light to converge) on the illumination area of the wavelength converter 6 (phosphor layer 63 of wavelength conversion element 61) as described above but also parallelizes the fluorescence emitted from the wavelength converter 6 and outputs the fluorescence to the polarization separation layer 555 described above. The second light collecting element 59 is formed of three pickup lenses 591 to 593 in the present embodiment, but the number of lenses that form the second light collecting element 59 is not limited to three, as in the case of the first light collecting element 57 described above.

### Configuration of Wavelength Converter

The wavelength converter 6 converts, in terms of wavelength, the blue excitation light incident thereon into fluorescence containing green light and red light. The wavelength converter 6 includes a rotating device 60 and the wavelength conversion element 61.

Out of the two components described above, the rotating device 60 is formed, for example, of a motor that rotates the wavelength conversion element 61 formed in a flat plate shape.

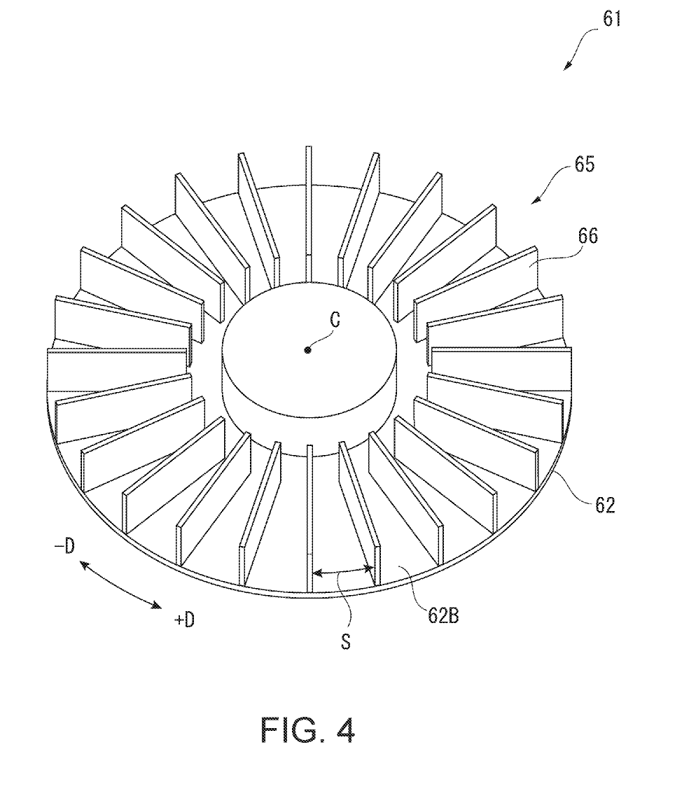

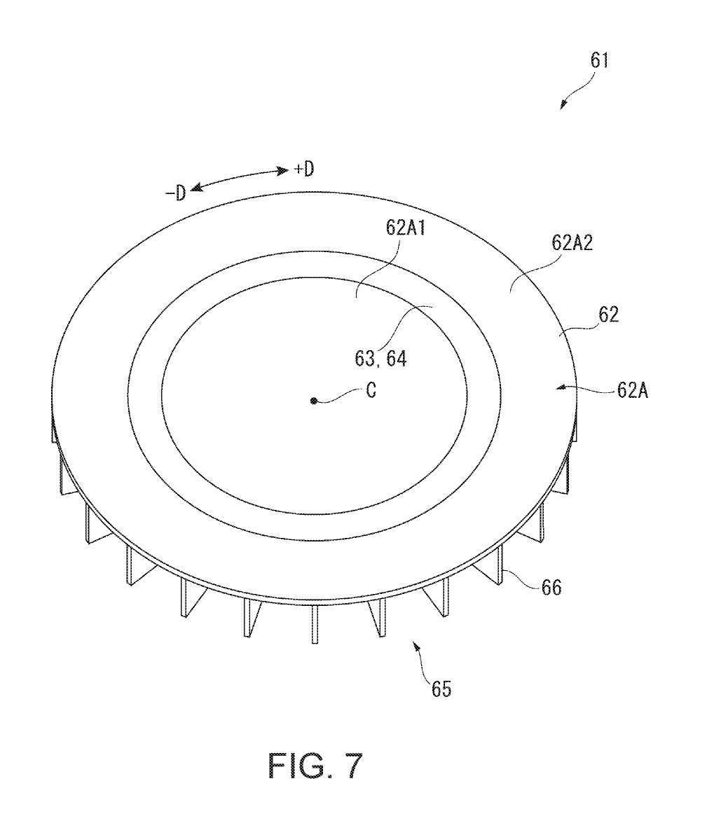

The wavelength conversion element 61 corresponds to an optical element in an aspect of the invention. The wavelength conversion element 61 includes a substrate 62, a phosphor layer 63 and a reflection layer 64, which are located on a light incident surface 62A (see FIG. 7), which is an excitation light incident surface of the substrate 62, and the heat dissipater 65, which is located on a surface 62B (see FIG. 4), which is the surface of the substrate 62 opposite the light incident surface 62A. Among the components described above, the configuration of the heat dissipater 65 will be described later in detail.

The substrate 62 is a flat-plate-shaped member formed in a roughly circular shape when viewed from the excitation light incident side. The substrate 62 can be made, for example, of a metal or ceramic material.

The phosphor layer 63 corresponds to an optical element layer in an aspect of the invention. The phosphor layer 63 is a layer containing a phosphor that emits, when excited with the excitation light incident thereon, fluorescence (fluorescence having a peak wavelength within a wavelength range, for example, from 500 to 700 nm), which is non-polarized light, and the phosphor layer 63 is the illumination area illuminated with the light from the homogenizer optical apparatus 54 and the second light collecting element 59 described above. Part of the fluorescence produced in the phosphor layer 63 is directed toward the second light collecting element 59, and the other part is directed toward the reflection layer 64.

The reflection layer 64 is disposed between the phosphor layer 63 and the substrate 62 and reflects the fluorescence incident from the phosphor layer 63 toward the second light collecting element 59.

When the thus configured wavelength conversion element 61 is irradiated with the excitation light, the phosphor layer 63 and the reflection layer 64 diffusively output the fluorescence described above toward the second light collecting element 59. The fluorescence is then incident via the second light collecting element 59 on the polarization separation layer 555 of the light combiner 55, passes through the polarization separation layer 555 along the second illumination optical axis Ax2, and is incident on the homogenizing apparatus 7. That is, the fluorescence, which passes through the light combiner 55, is incident, along with the excitation light, which is the blue light reflected off the light combiner 55, as the illumination light WL on the homogenizing apparatus 7.

### Configuration of Homogenizing Apparatus

The homogenizing apparatus 7 homogenizes the illuminance in a plane perpendicular to the center axis of the illumination light (plane perpendicular to optical axis) incident from the light source apparatus 5 and hence homogenizes the illuminance distribution in an image formation area (modulation area) or an illumination area of each of the light modulators 44 (44R, 44G, and 44B). The homogenizing apparatus 7 includes a first lens array 71, a second lens array 72, a polarization conversion element 73, and a superimposing lens 74. These components (reference characters 71 to 74) are so disposed that the optical axes thereof coincide with the second illumination optical axis Ax2.

The first lens array 71 has a configuration in which a plurality of lenslets 711 are arranged in a matrix in a plane perpendicular to the second illumination optical axis Ax2, and the plurality of lenslets 711 divide the illumination light WL incident thereon into a plurality of sub-light fluxes.

The second lens array 72 has a configuration in which a plurality of lenslets 721 are arranged in a matrix in a plane perpendicular to the second illumination optical axis Ax2, as in the case of the first lens array 71, and the lenslets 721 and the corresponding lenslets 711 are in a one-to-one relationship. The lenslets 721, along with the superimposing lens 74, superimpose the plurality of divided sub-light fluxes from the lenslets 711 on one another in the above-mentioned image formation area of each of the light modulators 44.

The polarization conversion element 73 is disposed between the second lens array 72 and the superimposing lens 74 and has the function of aligning the polarization directions of the plurality of sub-light fluxes incident on the polarization conversion element 73 with one another.

### Configuration of Heat Dissipater of Wavelength Conversion Element

FIG. 4 is a perspective view of the wavelength conversion element 61 viewed from the side facing the surface 62B.

The wavelength conversion element 61 includes the heat dissipater 65, which is located on the surface 62B of the substrate 62, as described above. The heat dissipater 65 has the plurality of fins 66, and the fins 66 each extend from the side facing the center of rotation C of the substrate 62 along the direction toward the outer circumference of the substrate 62, as shown in FIG. 4.

Specifically, the fins 66 radially extend from the side facing the center of rotation C toward the outer circumference of the substrate 62 and are arranged at equal intervals in the circumferential direction of the circular substrate 62, that is, in a +D direction, which is the rotational direction of the substrate 62.

The dimension of each of the fins 66 in the direction perpendicular to the extension direction of the fin 66 (thickness dimension in D direction) is roughly fixed across the entire fins 66, but the thickness dimension may instead increase with distance from the side facing the center of rotation C toward the outer circumference.

Further, the fins 66 are so formed that the dimension between the fins 66 in the +D direction, that is, a channel width S between the fins 66 in the direction perpendicular, in a plan view, to the extension direction of a channel through which the cooling gas passes through the spaces between the fins 66 from the side facing the center of rotation C toward the outer circumference falls within a predetermined range.

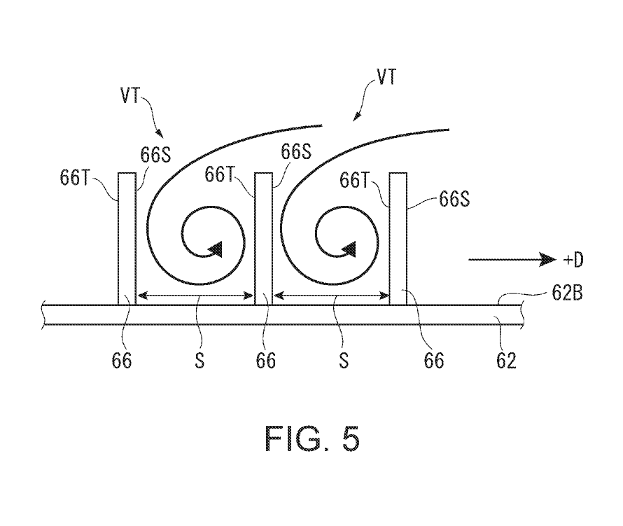

FIG. 5 is a diagrammatic view showing vortices VT produced by the fins 66 when the wavelength conversion element 61 is rotated.

In a case where the wavelength conversion element 61 is rotated around the center of rotation C in the +D direction, negative pressure is produced on the side facing opposite the +D direction with respect to the fins 66 (−D-direction side), and the vortices VT of the cooling gas are produced, as shown in FIG. 5, when the channel width S described above is greater than or equal to a predetermined value. In this case, the cooling gas flows through the spaces between the fins 66 from the side facing the center of rotation C toward the outer circumference with the vortices VT produced. Each of the thus produced vortices VT swirls around an axis extending along the extension direction of the fins 66 in such a way that the vortex VT collides with the facing end surfaces of two fins 66 adjacent to each other in the +D direction (two fins 66 that sandwich vortex VT) (facing end surface are −D-direction-side end surface 66T of +D-direction-side fin 66 and +D-direction-side end surface 66S of −D-direction-side fin 66), so that the heat transferred to the fins 66 is likely to be transferred to the cooling gas, and the fins 66 are likely to be cooled. That is, the fins 66 and hence the wavelength conversion element 61 are cooled with improved efficiency.

### Setting of Channel Width

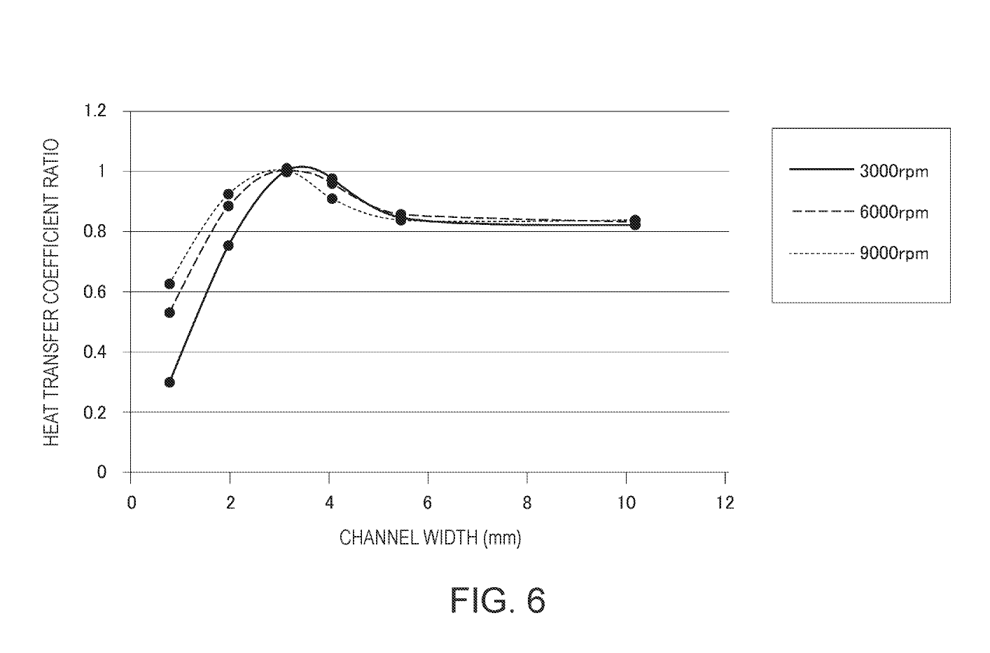

FIG. 6 shows graphs illustrating the relationship between the channel width S described above and a heat transfer coefficient ratio for each rotational speed (number of revolutions per unit time) of the wavelength conversion element 61. The heat transfer coefficient ratio is a value representing the ratio of the heat transfer coefficient for each channel width S to the largest heat transfer coefficient, provided that the rotational speed is fixed.

In a case where the wavelength conversion element 61 is rotated at 3000, 6000, and 9000 rpm, which are practical rotational speeds, the heat transfer coefficient ratio described above, which represents heat transfer from the fins 66 to the cooling gas, changes with the channel width S between the fins 66 described above, as shown in FIG. 6. The heat transfer coefficient changes in the same manner irrespective of the rotational speed of the wavelength conversion element 61, 3000 rpm (solid line in FIG. 6), 6000 rpm (broken line in FIG. 6), and 9000 rpm (dotted line in FIG. 6).

Specifically, over the range of the channel width S greater than or equal to 1 mm and smaller than or equal to 10 mm, the heat transfer coefficient ratio described above increases as the channel width S increases from 1 mm in all cases where the wavelength conversion element is rotated at the three rotational speeds described above. The heat transfer coefficient ratio is maximized when the channel width S is 3 mm and decreases as the channel width S increases from 4 mm. When the channel width S is greater than 6 mm, the heat transfer coefficient is roughly fixed.

That is, the heat transfer coefficient ratio and hence the heat transfer coefficient, which represents heat transfer from the fins 66 to the cooling gas, is large when the channel width S is greater than or equal to 3 mm and smaller than or equal to 6 mm, in more detail, the heat transfer coefficient is maximized when the channel width S is greater than or equal to 3 mm and smaller than or equal to 5 mm.

In the simulation for generating the graphs shown in FIG. 6, a standing dimension of the fins 66 measured from the substrate 62 (dimension in the direction along the axis of rotation of the substrate 62) is so set at 3 mm or greater, in more detail, 10 mm that the vortices VT described above are produced. Further, in the simulation, the diameter of the substrate 62 is set at 100 mm, and the fins 66 are formed within an area defined around the center of rotation C and having a diameter of 90 mm.

A high value of the heat transfer coefficient, which represents heat transfer from the fins 66 to the cooling gas, indicates that heat generated in the phosphor layer 63 and transferred to the fins 66 via the substrate 62 is transferred to the cooling gas with high efficiency, that is, the wavelength conversion element 61 is cooled with high efficiency. In other words, the above description indicates that in the case where the channel width S described above is greater than or equal to 3 mm and smaller than or equal to 6 mm, the wavelength conversion element 61 is cooled with high efficiency, and in the case where the channel width S is greater than or equal to 3 mm and smaller than or equal to 5 mm, the wavelength conversion element 61 is cooled with higher efficiency. The range of the channel width S that allows the above-mentioned improvement in cooling efficiency (greater than or equal to 3 mm and smaller than or equal to 6 mm) is hereinafter referred to as an adequate channel width range. The adequate channel width range corresponds to the predetermined dimension range in an aspect of the invention.

The high cooling efficiency described above is believed to be achieved because a vortex VT is produced in the spaces between two fins 66 when the wavelength conversion element 61 rotates, and the vortex VT effectively collides with the above-mentioned end surface 66T of the +D-direction-side fin 66 and the above-mentioned end surface 66S of the −D-direction-side fin 66, so that the heat is likely to be transferred from the fins 66 to the cooling gas, as described above.

On the other hand, it is believed that when the channel width S is 1 mm, the vortex VT described above is unlikely to be produced because the channel width S is too narrow, so that the heat transfer coefficient is relatively small.

Further, it is believed that when the channel width S is greater than 6 mm, the vortex VT produced in the space between the fins 66 is unlikely to collide with the −D-direction-side fin 66 because the channel width S is too large, so that the heat transfer coefficient is fixed.

The relationship between the channel width S and the heat transfer coefficient does not depend on the diameter of the substrate 62.

Area where Channel Width within Range Described Above is Set

As described above, the vortices VT produced when the wavelength conversion element 61 is rotated improve the efficiency of cooling of the wavelength conversion element 61. The channel width S between the fins 66 that allows the vortices VT to be produced does not necessarily fall within the adequate channel width range described above over the entire length of the fins 66 from the ends on the side facing the center of rotation C to the ends on the side facing the outer circumference.

FIG. 7 is a perspective view of the wavelength conversion element 61 viewed from the light incident side.

The phosphor layer 63 and the reflection layer 64 described above are located on the light incident surface 62A of the substrate 62 and in an area inside the outer edge thereof and having an annular shape around the center of rotation C, as shown in FIG. 7. The heat generated in the thus located phosphor layer 63 is transferred not only to an inner circumferential area 62A1 of the substrate 62, which is the area inside the inner circumference of the phosphor layer 63, but also to an outer circumferential area 62A2 of the substrate 62, which is the area outside the outer circumference of the phosphor layer 63. Since the flow speed of the cooling gas flowing through the spaces between the fins 66 when the substrate 62 rotates increases with distance from the center of rotation C toward the outer circumference, the outer circumferential area 62A2 is more likely to be cooled than the inner circumferential area 62A1, and the heat generated in the phosphor layer 63 is more likely to be transferred to the outer circumferential area 62A2 than to the inner circumferential area 62A1.

Therefore, although not shown, across the plurality of fins 66 located on the substrate 62, when the channel width S at least in the portion corresponding to the outer circumferential area 62A2 is so set as to fall within the adequate channel width range described above, vortices VT produced in the portion are allowed to adequately collide with the fins 66 that sandwich the vortices VT. The fins 66 and hence the wavelength conversion element 61 can therefore be cooled with improved efficiency.

Further, when the channel width S in the portion corresponding to the inner circumferential area 62A1, as well as the outer circumferential area 62A2, is also so set as to fall within the adequate channel width range described above, the wavelength conversion element 61 can be cooled with further improved efficiency. On the other hand, it goes without saying that setting the channel width S only in the portion corresponding to the inner circumferential area 62A1 or the channel width S only between part of the fins 66 to fall within the adequate channel width range described above allows improvement in the cooling efficiency as compared with a wavelength conversion element in which the channel width S across the entire fins is set to a value outside the adequate channel width range.

### Effects of First Embodiment

The projector 1 according to the present embodiment described above provides the following effects.

The dimension in the +D direction between two fins 66 adjacent to each other in the +D direction (that is, channel width S described above) is so set as to fall within the adequate channel width range described above. The setting described above allows a vortex VT of the cooling gas to be readily produced between two fins 66 when the wavelength conversion element 61 rotates and further allows the vortex VT to readily collide with the facing end surfaces 66S and 66T of the two fins 66 that sandwich the vortex VT. As a result, the cooling air is allowed to effectively collide with the fins 66, whereby the heat in the fins 66 can be readily transferred to the cooling gas. Therefore, the heat generated in the phosphor layer 63 can be efficiently cooled, and the wavelength conversion element 61 can be cooled with improved efficiency. Further, since the wavelength conversion element 61 is thus stabilized, the light source apparatus 5 can stably output light, whereby the reliability of the projector 1 can be improved.

The heat generated in the phosphor layer 63 is likely to be transferred from the phosphor layer 63 to the outer circumferential area 62A2, as described above. In correspondence with this, the fact that the channel width S between fins 66 corresponding at least to the outer circumferential area 62A2 is so set as to fall within the adequate channel width range described above reliably allows improvement in the efficiency of cooling of the outer circumferential area 62A2. The efficiency of cooling of the wavelength conversion element 61 can therefore be reliably improved.

The channel width S between the fins 66 is so set as to fall within the adequate channel width range described above across the entire fins 66. The heat transfer from the fins 66 to the cooling gas can therefore be more efficient than in a case where the channel width S only in the portion corresponding to the outer circumferential area 62A2 or only in the portion corresponding to the inner circumferential area 62A1 is so set as to fall within the adequate channel width range. The efficiency of cooling of the wavelength conversion element 61 can therefore be more reliably improved.

The adequate channel width range described above is set in accordance with the size of the vortices VT described above. The adequate channel width range can therefore be so set that each of the produced vortices VT collides with two fins 66 that sandwich the vortex VT. When the fins 66 are so configured that the channel width S falls within the adequate channel width range, the efficiency of cooling of the wavelength conversion element 61 can be reliably improved.

The adequate channel width range described above is greater than or equal to 3 mm and smaller than or equal to 6 mm. In this case, not only can the vortices VT described above be produced reliably in the space between the two fins 66 when the wavelength conversion element 61 rotates, but also each of the vortices VT is allowed to reliably collide with the two fins that sandwich the vortex VT. The efficiency of cooling of the wavelength conversion element 61 can therefore be reliably improved.

The dimension of the fins 66 along the axis of rotation of the wavelength conversion element 61 (standing dimension of the fins 66 measured from the substrate 62) is at least 3 mm. In this case, the vortices VT are allowed to be unlikely to collide with the surface 62B, which is the bottom surface of the substrate 62, whereby the vortices VT can be readily continuously produced. The efficiency of cooling of the wavelength conversion element 61 can therefore be more reliably improved.

### Second Embodiment

A second embodiment of the invention will next be described.

A projector according to the present embodiment has the same configuration as that of the projector 1 described above but differs therefrom in terms of the shape of the fins with which the wavelength conversion element is provided. In the following description, the same or roughly the same portions as those having been already described have the same reference characters and will not be described.

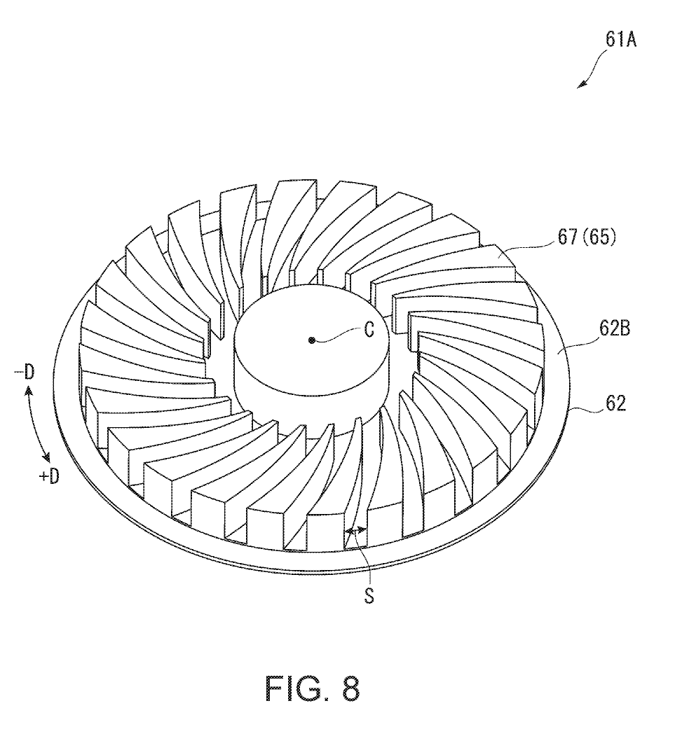

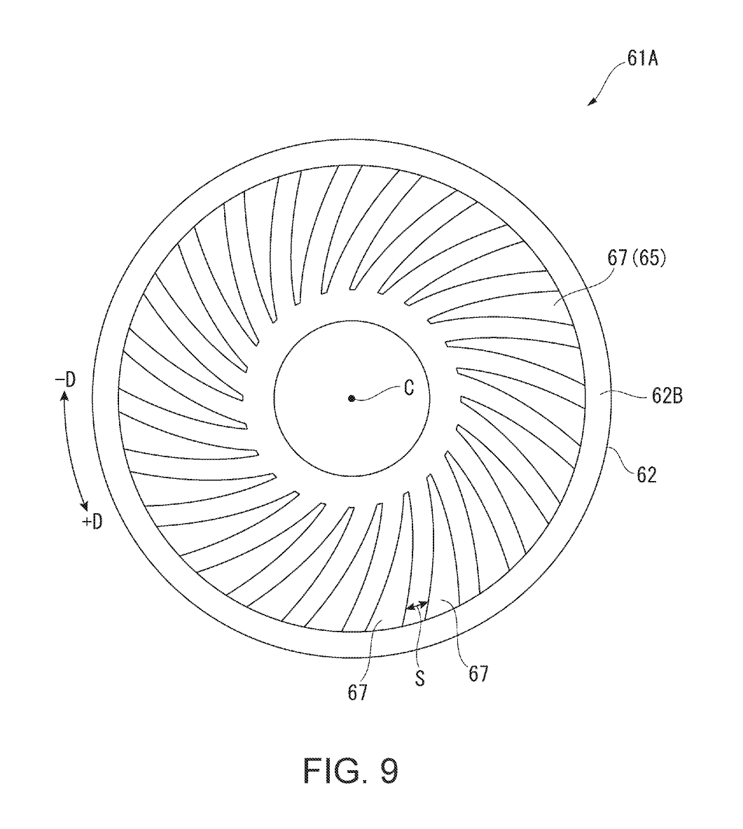

FIGS. 8 and 9 are a perspective view and a plan view of a wavelength conversion element 61A provided in the light source apparatus 5 of the projector according to the present embodiment and viewed from the side opposite the light incident side. In FIGS. 8 and 9, only part of fins 67 is labeled with the reference character for clarity.

The projector according to the present embodiment has the same configuration and function as those of the projector 1 described above except that the wavelength conversion element 61 is replaced with the wavelength conversion element 61A. The wavelength conversion element 61A has the same configuration and function as those of the wavelength conversion element 61 described above except that the plurality of fins 66 described above are replaced with a plurality of fins 67.

The plurality of fins 67 form the heat dissipater 65 in the present embodiment. The fins 67 extend along the direction from the center of rotation C of the substrate 62 toward the outer circumference thereof and are arranged at equal intervals along the outer circumference of the substrate 62, as in the case of the fins 66.

On the other hand, the fins 67 each have a curved shape (arcuate shape) that warps toward the −D-direction side (side facing opposite +D direction, which is rotational direction of wavelength conversion element 61A), with distance from the side facing the center of rotation C toward the outer circumference. The dimension of each of the fins 67 in the direction perpendicular to the extension direction of the fins 67 (thickness direction in D direction) also increases with distance from the end facing the center of rotation C toward the end facing the outer circumference. The shape described above is intended to make the channel width S between the fins 67 constant.

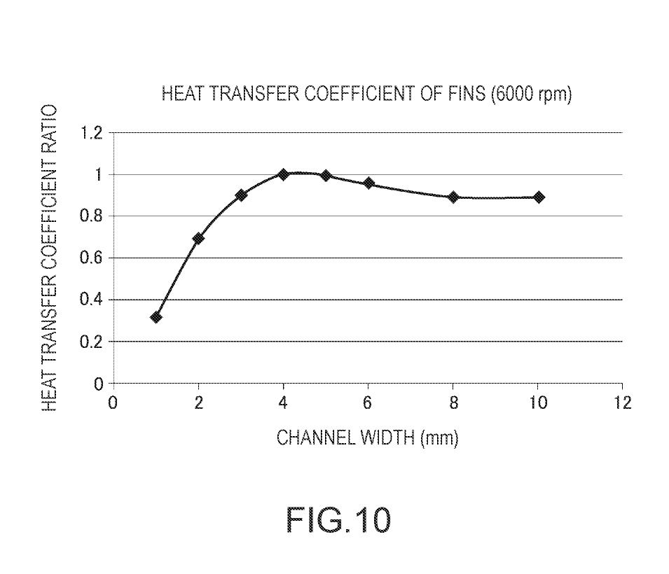

FIG. 10 shows a graph illustrating the relationship described above between the channel width S and the heat transfer coefficient ratio in a case where the wavelength conversion element 61A is rotated at a speed of 6000 rpm.

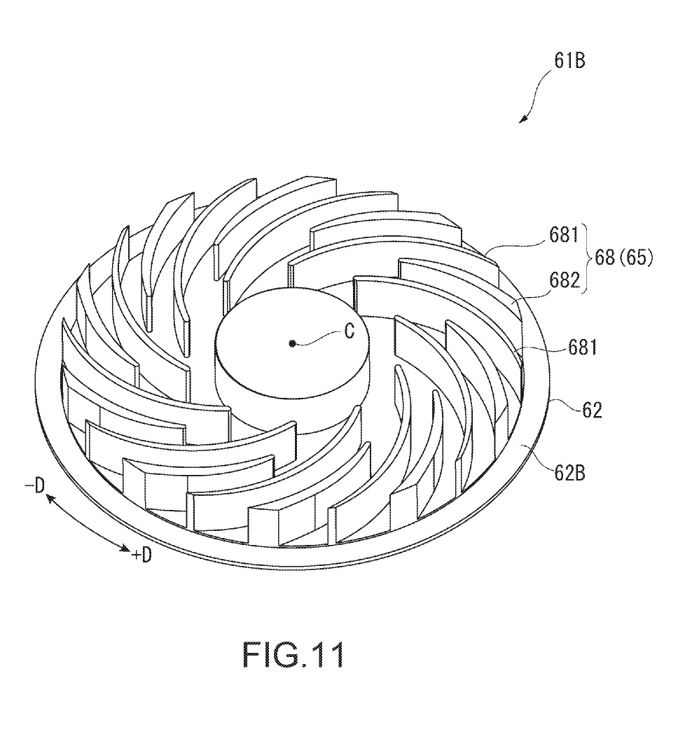

Also in the case of the wavelength conversion element 61A described above, the heat transfer coefficient ratio, which represents heat transfer from the fins 67 to the cooling gas, increases over the range of the channel width S described above greater than or equal to 3 mm and smaller than or equal to 6 mm (adequate channel width range) and is maximized over the range of the channel width S greater than or equal to 4 mm and smaller than or equal to 5 mm, as shown in FIG. 11. Although not shown, the same tendency is shown in cases where the wavelength conversion element 61A is rotated at speeds of 3000 rpm and 9000 rpm.

Therefore, even in the case of the fins 67 having the shape described above, when the channel width S between the fins 67 is so set as to fall within the adequate channel width range described above, the heat can be efficiently transferred from the fins 67 to the cooling gas, whereby the wavelength conversion element 61A can be cooled with improved efficiency.

In the present embodiment, in consideration of the tendency described above, the channel width S between the fins 67 is set at a fixed value of 4 mm from the end on the side facing the center of rotation C to the end on the side facing the outer circumference, but not necessarily. The channel width S between the fins 67 may be set at another fixed value or may change within a predetermined range of the channel width S (within the adequate channel width range described above, for example). In this case, the above-mentioned thickness dimension of the fins 67 may not increase with distance from the end on the side facing the center of rotation C toward the end on the side facing the outer circumference.

### Effects of Second Embodiment

The projector according to the present embodiment described above can provide the following effect as well as the same effects as those provided by the projector 1 described above.

The fins 67 each have a curved shape (arcuate shape) that warps toward the −D-direction side with distance from the side facing the center of rotation C toward the outer circumference. Since the fins 67 are therefore not perpendicular to the +D direction, the rotational resistance (air resistance) of the wavelength conversion element 61A can be reduced as compared with the wavelength conversion element 61, in which the fins 66 radially extend. The load acting on the rotating device 60 can therefore be reduced.

### Third Embodiment

A third embodiment of the invention will next be described.

A projector according to the present embodiment has the same configuration as that of the projector 1 described above but differs therefrom in that the fins with which the wavelength conversion element is provided are formed of two types of differently dimensioned fins. In the following description, the same or roughly the same portions as those having been already described have the same reference characters and will not be described.

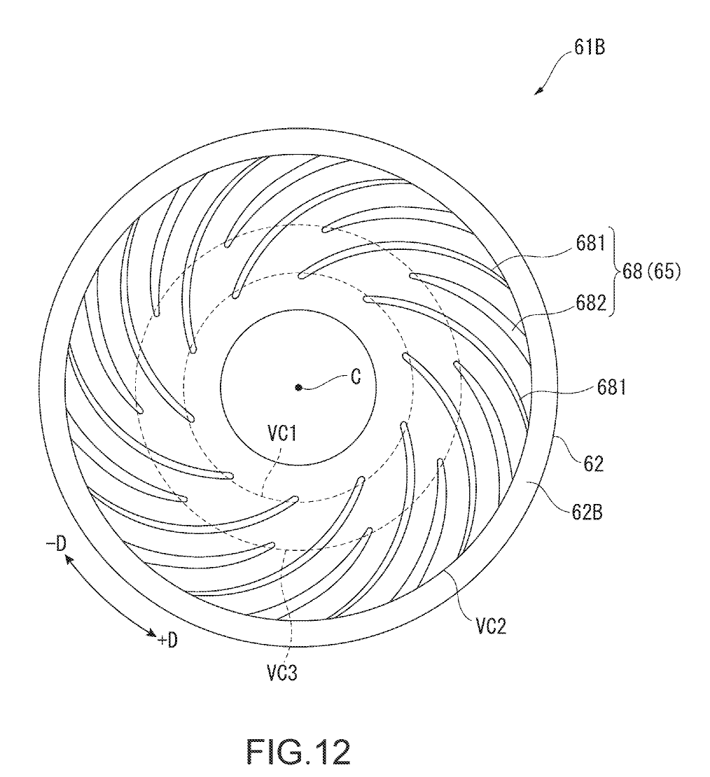

FIGS. 11 and 12 are a perspective view and a plan view of a wavelength conversion element 61B provided in the light source apparatus 5 of the projector according to the present embodiment and viewed from the side opposite the light incident side. In FIGS. 11 and 12, only part of fins 68 is labeled with the reference character for clarity.

The projector according to the present embodiment has the same configuration and function as those of the projector 1 described above except that the wavelength conversion element 61 is replaced with the wavelength conversion element 61B. The wavelength conversion element 61B has the same configuration as that of the wavelength conversion element 61 described above except that the plurality of fins 66 are replaced with a plurality of fins 68.

The plurality of fins 68 form the heat dissipater 65 in the present embodiment. The fins 68 include a plurality of first fins 681 and a plurality of second fins 682.

The first fins 681 extend along the direction from the center of rotation C of the substrate 62 toward the outer circumference thereof, are arranged at equal intervals along the outer circumference of the substrate 62 (in other words, in +D direction), and each have a curved shape (arcuate shape) that warps toward the −D-direction side with distance from the side facing the center of rotation C toward the outer circumference, as in the case of the fins 67. The dimension of the first fins 681 in the direction perpendicular to the extension direction thereof (thickness direction) is roughly fixed.

The ends of the first fins 681 on the side facing the center of rotation C are located on a first virtual circle VC1 around the center of rotation C, as shown in FIG. 12. On the other hand, the ends of the first fins 681 on the outer circumference side are located on a second virtual circle VC2, the center of which coincides with the center of rotation C and the diameter of which is greater than the diameter of the first virtual circle VC1 but smaller than the diameter of the substrate 62. For example, in the case where the diameter of the substrate 62 is 100 mm as described above, the diameter of the second virtual circle VC2 is 90 mm.

The second fins 682 are located between the plurality of first fins 681. The second fins 682 extend along the direction from the center of rotation C toward the outer circumference, are arranged at equal intervals along the outer circumference of the substrate 62 (in other words, in +D direction), and each have a curved shape (arcuate shape) that warps toward the −D-direction side with distance from the side facing the center of rotation C toward the outer circumference, as in the case of the first fins 681 described above.

The ends of the second fins 682 on the side facing the center of rotation C are located on a third virtual circle VC3, the center of which coincides with the center of rotation C and the diameter of which is greater than the diameter of the first virtual circle VC1 but smaller than the diameter of the second virtual circle VC2. On the other hand, the ends of the second fins 682 on the side facing the outer circumference are located on the second virtual circle VC2.

The dimension of the second fins 682 in the direction perpendicular to the extension direction of the second fins 682 (thickness direction) is so set as to increase with distance toward the outer circumference so that the dimension in the +D direction between each pair of two first fins 681 that sandwich the corresponding second fin 682 in the +D direction (channel width S) is so set as to fall within the adequate channel width range described above.

In the thus configured wavelength conversion element 61B, in the area from the first virtual circle VC1 to the third virtual circle VC3, the channel width S between two first fins 681 adjacent to each other is so set as to fall within the adequate channel width range described above. That is, out of two first fins 681 adjacent to each other in the +D direction, the dimension in the +D direction between the −D-direction-side end surface of the +D-direction-side first fin 681 and the +D-direction-side end surface of the −D-direction-side first fin 681 is so set as to fall within the adequate channel width range described above.

On the other hand, in the area from the third virtual circle VC3 to the second virtual circle VC2, the channel width S between each first fin 681 and a second fin 682 adjacent thereto in the +D direction is so set as to fall within the adequate channel width range described above. That is, the dimension in the +D direction between the −D-direction-side end surface of the +D-direction-side first fin 681 and the +D-direction-side end surface of the −D-direction-side second fin 682 is so set as to fall within the adequate channel width range described above. Similarly, the dimension in the +D direction between the −D-direction-side end surface of the +D-direction-side second fin 682 and the +D-direction-side end surface of the −D-direction-side first fin 681 is so set as to fall within the adequate channel width range described above.

As described above, in the wavelength conversion element 61B, the channel widths S between the fins 68 are so set as to fall within the adequate channel width range described above.

It is noted that as long as the channel width S between each first fin 681 and a second fin 682 adjacent thereto that correspond to the outer circumferential area 62A2 described above is so set as to fall within the adequate channel width range described above, the channel width S between the first fins 681 that corresponds to the inner circumferential area 62A1 described above and the channel width S between each first fin 681 and a second fin 682 adjacent thereto that correspond to the inner circumferential area 62A1 may be values outside the adequate channel width range described above. On the other hand, regarding the above-mentioned effect provided by the produced vortices VT, the effect can be provided when there is a portion where the channel width S between the first fins 681 or the channel width S between each first fin 681 and a second fin 682 adjacent thereto is so set as to fall within the adequate channel width range described above.

### Effects of Third Embodiment

The projector according to the present embodiment described above can provide the following effect as well as the same effects as those provided by the projectors shown in the first and second embodiments described above.

For example, to form fins on the substrate in a cutting process, it is difficult in some cases to set the channel width S between the fins to fall within the adequate channel width range described above depending on the size of a cutting tool. In other words, the channel width S could undesirably increase to a value beyond the adequate channel width range described above.

In contrast, in the case where the fins 68 including the first fins 681 and the second fins 682 are formed on the substrate 62 in a cutting process, since the dimension between the ends of the first fins 681 on the side facing the center of rotation C can be a large value to the extent the value falls within the adequate channel width range described above, the cutting tool is allowed to readily pass through the spaces between the fins. Therefore, since the fins 68 can be readily formed with the cutting tool, the substrate 62 can be readily processed, whereby an increase in manufacturing cost of the wavelength conversion element 61B can be suppressed.

### Fourth Embodiment

A fourth embodiment of the invention will next be described.

A projector according to the present embodiment has the same configuration as that of the projector 1 described above but differs therefrom in that the angle of the fins with respect to the radial direction of the wavelength conversion element (substrate) is adequately set. In the following description, the same or roughly the same portions as those having been already described have the same reference characters and will not be described.

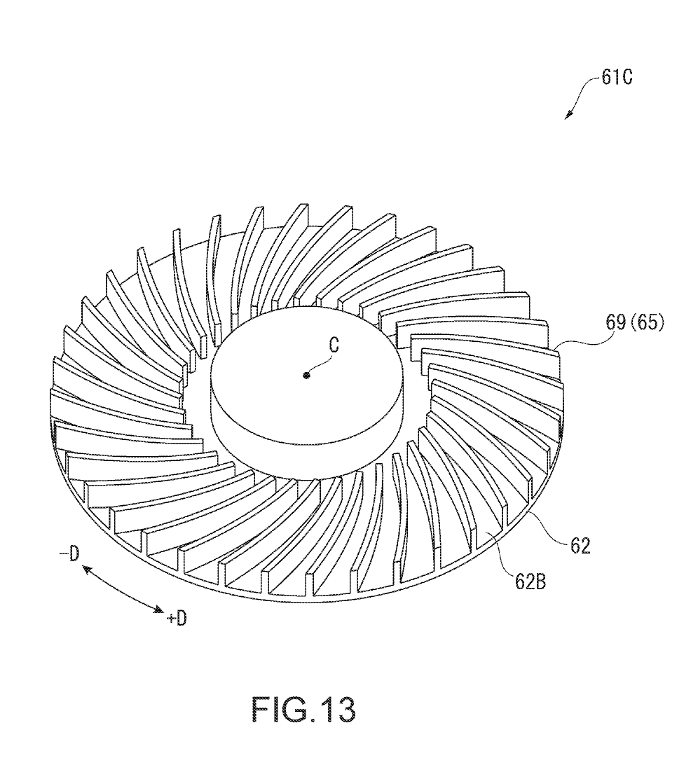

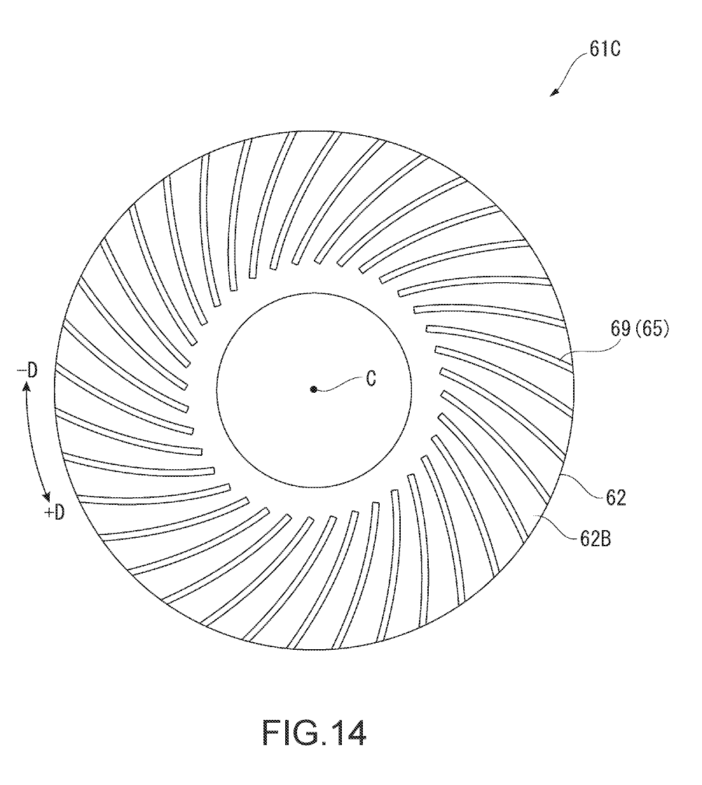

FIGS. 13 and 14 are a perspective view and a plan view of a wavelength conversion element 61C provided in the light source apparatus 5 of the projector according to the present embodiment and viewed from the side opposite the light incident side. In FIGS. 13 and 14, only part of fins 69 is labeled with the reference character for clarity.

The projector according to the present embodiment has the same configuration and function as those of the projector 1 described above except that the wavelength conversion element 61 is replaced with the wavelength conversion element 61C. The wavelength conversion element 61C has the same configuration as that of the wavelength conversion element 61 described above except that the plurality of fins 66 are replaced with a plurality of fins 69.

The plurality of fins 69 form the heat dissipater 65 in the present embodiment. The fins 69 extend along the direction from the center of rotation C of the substrate 62 toward the outer circumference thereof, are arranged at equal intervals along the outer circumference of the substrate 62 (in other words, in +D direction), and each have a curved shape (arcuate shape) that warps toward the −D-direction side with distance from the side facing the center of rotation C toward the outer circumference, as in the case of the fins 67. The dimension in the direction perpendicular to the extension direction of the fins 69 (thickness direction) is roughly fixed.

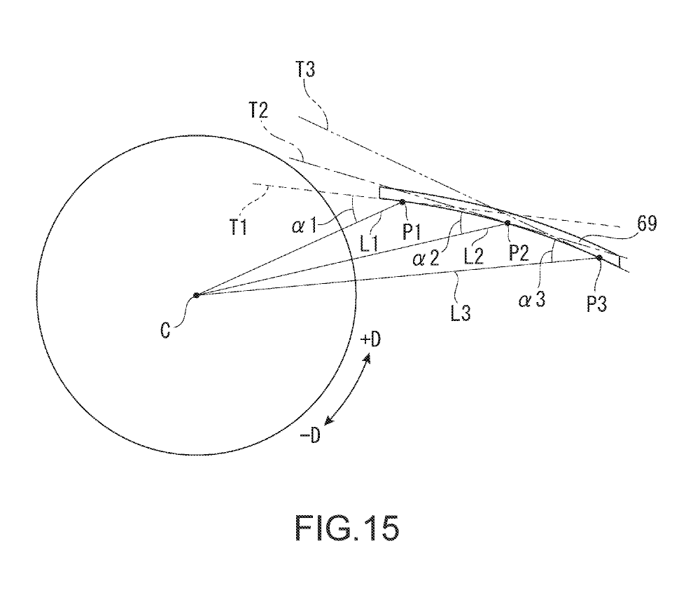

FIG. 15 describes the intersection angle between a tangent corresponding to a position on a −D-direction-side edge of the fin 69 and the radial direction originating from the center of rotation C.

The fins 69 each have the curved shape as described above, but each of the fins 69 has a radius of curvature that changes with the position on the fin in such a way that in all positions on the fin 69, the intersection angle between the direction of the line tangent to the fin 69 and the radial direction originating from the center of rotation C is fixed. In detail, the fins 69 are each so formed that the radius of curvature increases with distance from the side facing the center of rotation C toward the outer circumference.

Specifically, along the −D-direction-side edge of one fin 69, let T1, T2, and T3 be lines tangent to the fin 69 at a point P1 on the side facing the center of rotation C, a point P2 roughly at the center, and a point P3 on the side facing the outer circumference, and let L1, L2, and L3 be straight lines that pass through the points P1 to P3 and extend in the radial direction originating from the center of rotation C, as shown in FIG. 15. Under the definitions described above, an intersection angle α1 between the tangent T1 and the straight line L1, an intersection angle α2 between the tangent T2 and the straight line L2, and an intersection angle α3 between the tangent T3 and the straight line L3 are roughly equal to one another. That is, each of the fins 69 is so formed that the intersection angle described above is fixed in any position on the −D-direction-side edge of the fin 69.

The intersection angle described above is hereinafter referred to as a tangent intersection angle of the fins 69.

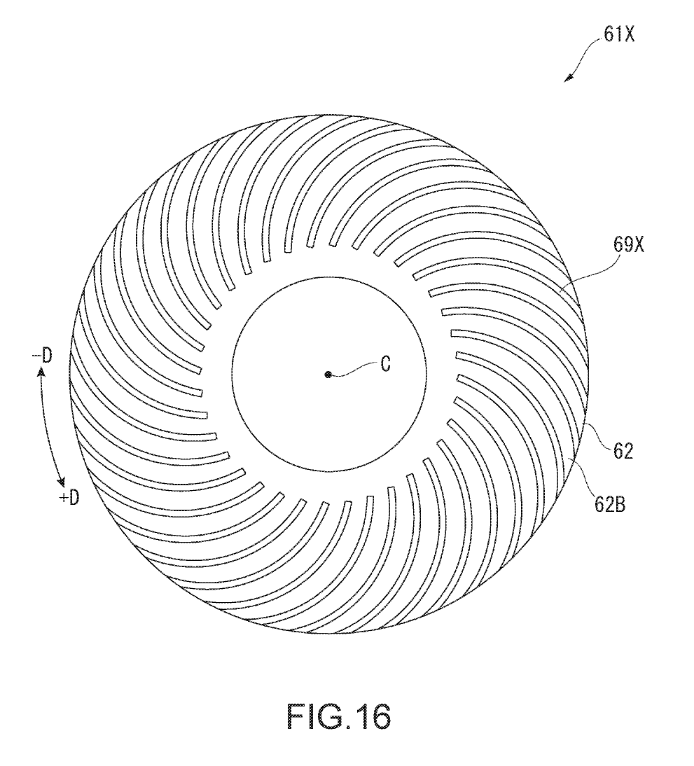

FIG. 16 is a plan view of a wavelength conversion element 61X presented as a comparative example of the wavelength conversion element 61C according to the present embodiment and viewed from the side opposite the light incident side. In FIG. 16, only part of fins 69X is labeled with the reference character for clarity.

A description will now be made of the wavelength conversion element 61X including the fins 69X so formed as to have a fixed radius of curvature.

The wavelength conversion element 61X has the same configuration as that of the wavelength conversion element 61C except that the plurality of fins 69 are replaced with a plurality of fins 69X, as shown in FIG. 16.

The fins 69X extend along the direction from the center of rotation C of the substrate 62 toward the outer circumference thereof, are arranged at equal intervals along the outer circumference of the substrate 62 (in other words, in +D direction), each have a curved shape (arcuate shape) that warps toward the −D-direction side with distance from the side facing the center of rotation C toward the outer circumference, and the dimension of the fins 69X in the direction perpendicular to the extension direction of the fins 69X (thickness direction) is roughly fixed, as in the case of the fins 69 described above.

The fins 69X, however, differ from the fins 69 in that the fins 69 are so formed that the tangent intersection angle of each of the fins is fixed, whereas the fins 69X are formed in an arcuate shape having fixed curvature (fixed radius of curvature) so that the tangent intersection angle is not fixed.

When the thus configured wavelength conversion element 61X is rotated, the intersection angle between the tangent to the fin 69X and the radial direction originating from the center of rotation C increases in an outer-circumference-side portion of the substrate 62. In other words, the intersection angle between the tangent to the fin 69X and the flowing direction of the cooling gas flowing through the space between the fin 69X and a fin 69X adjacent thereto toward the outer circumference increases. Therefore, in the outer-circumference-side portion, the fins 69X serve as walls against the cooling gas flowing through the space between the fins 69X toward the outer circumference, and the cooling gas undesirably stays between the fins 69X.

In this case, the cooling gas flowing through the space between the fins 69X toward the outer circumference primarily flows through a −D-direction-side area in the channel between the fins 69X, and the flow speed and flow rate of the cooling gas to be discharged out of the substrate 62 undesirably decrease. The efficiency of cooling of the wavelength conversion element 61X is therefore not very high.

In contrast, in the wavelength conversion element 61C described above, in which the radius of curvature changes with the position on each of the fins 69, the fins 69 can be so located as not to serve as walls against the cooling gas flowing through the spaces between the fins 69 toward the outer circumference. Specifically, since the fins 69 are so formed that the radius of curvature thereof increases with distance from the side facing the center of rotation C toward the outer circumference, the fins 69 are so located as not to serve as walls against the cooling gas. Therefore, the situation in which the cooling gas stays between the fins can be avoided, whereby decreases in the flow speed and flow rate of the cooling gas can be suppressed, and the efficiency of cooling of the wavelength conversion element 61C can therefore be improved.

### Intersection Angle Between Fins and Radial Direction

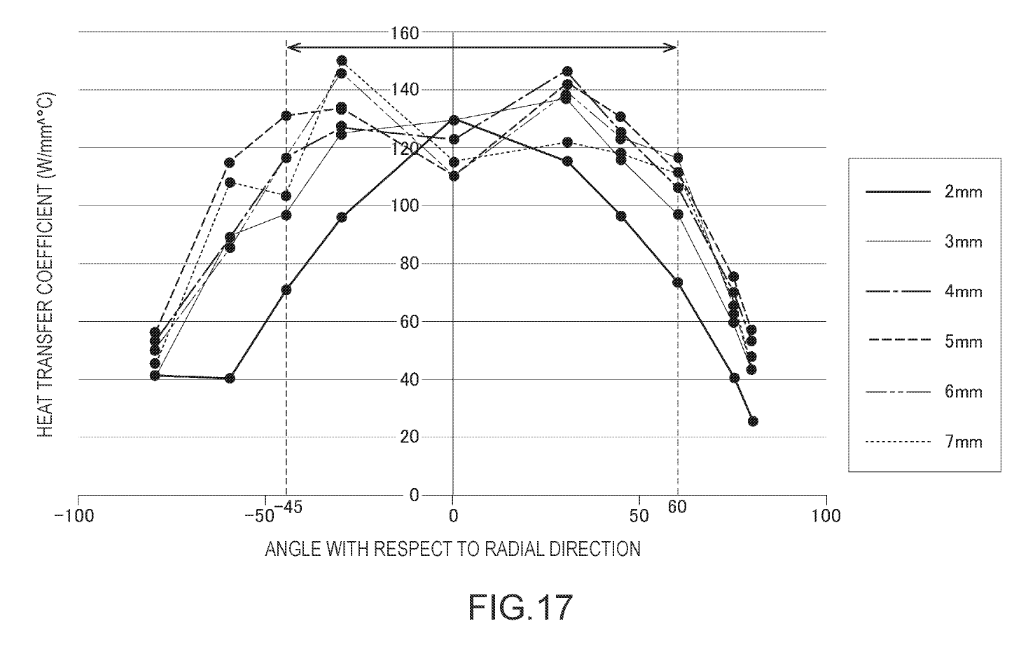

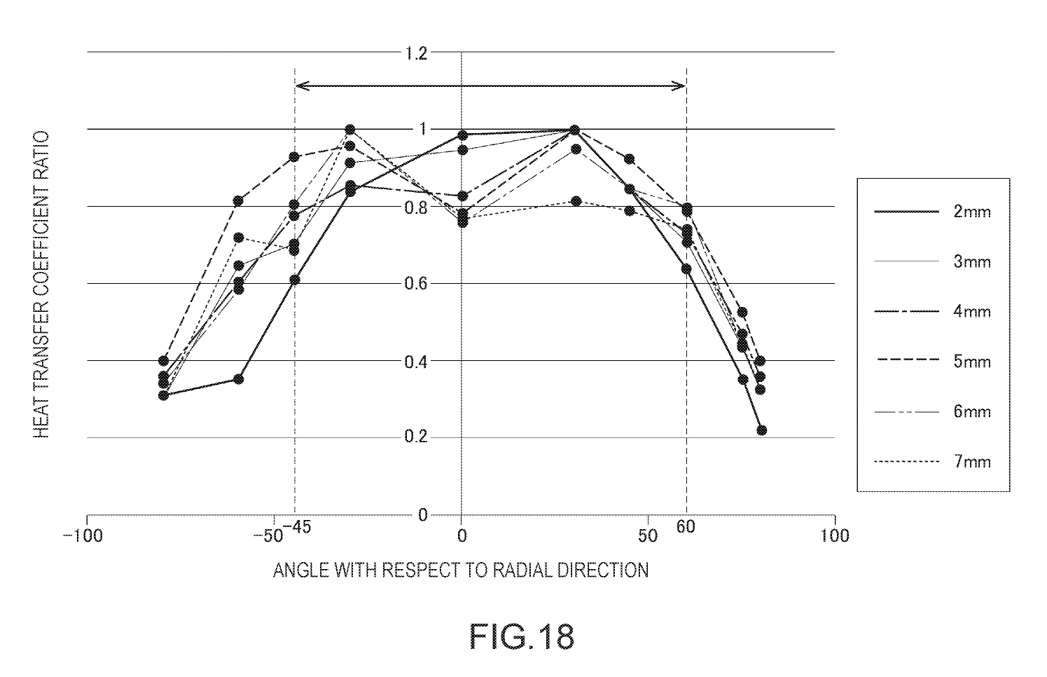

FIG. 17 shows graphs illustrating the relationship between the tangent intersection angle of the fins 69 and the heat transfer coefficient for each channel width S described above. FIG. 18 shows graphs illustrating the relationship between the tangent intersection angle and the heat transfer coefficient ratio described above for each channel width S described above.

The heat transfer coefficient and the heat transfer coefficient ratio, which represent heat transfer from a fin located on a wavelength conversion element rotated around the center of rotation C to the cooling gas, change with the tangent intersection angle of the fin, as shown in FIGS. 17 and 18.

Specifically, a plurality of wavelength conversion elements in each of which a plurality of fins having the tangent intersection angle greater than or equal to −80° and smaller than or equal to +80° are so formed that the channel width S described above between the fins is 2 mm, 3 mm, 4 mm, 5 mm, 6 mm, and 7 mm have high values of the heat transfer coefficient and the heat transfer coefficient ratio over the range of the tangent intersection angle greater than or equal to −45° and smaller than or equal to +60°. The regions where the tangent intersection angle is negative represent that the direction in which the fins are curved faces the side opposite the side described above, that is, the fins each have a shape that warps toward the +D-direction side with distance from the side facing the center of rotation C toward the outer circumference.

As described above, it is believed that when a plurality of fins having the tangent intersection angle set to be greater than or equal to −45° and smaller than or equal to +60° (hereinafter referred to as adequate angle range), the vortices VT described above are likely to be produced, whereby a wavelength conversion element having a high coefficient of heat transfer to the cooling gas can be formed.

On the other hand, in the regions where the tangent intersection angle has values outside the adequate angle range described above, in which the fins each have a shape that follows the +D direction, it is believed that the vortices VT described above are unlikely to be produced, and the coefficient of heat transfer to the cooling gas decreases.

An outer-circumferential-side portion where the tangent intersection angle is greater than or equal to −45° and smaller than 0° drags the cooling gas toward the center of rotation C when the substrate 62 is rotated. As a result, pressure that causes the cooling gas to flow from the side facing the outer circumference toward the center of rotation C is produced in the portion. In the portion, the direction of the pressure that causes the cooling gas to flow toward the outer circumference and the direction of the pressure that causes the cooling gas to flow toward the center of rotation C faces each other, undesirably resulting in decreases in the flow speed and flow rate of the cooling gas that flows toward the outer circumference and exits. That is, the efficiency of cooling of the wavelength conversion element 61C could undesirably decrease.

In contrast, a fin that allows the intersection angle with respect to the radial direction to be greater than 0° and smaller than or equal to +60°, that is, a fin that warps toward the −D-direction side with the distance from the side facing the center of rotation C toward the outer circumference does not drag the cooling gas toward the center of rotation C, whereby decreases in the flow speed and flow rate of the cooling gas that flows toward the outer circumference and exits can be suppressed.

On the other hand, when the tangent intersection angle of a fin is 0°, that is, when a fin radially extends from the side facing the center of rotation C, the fin is perpendicular to the +D direction. Therefore, the rotational resistance of the wavelength conversion element increases, and the load acting on the rotating device 60 increases, as described above.

In consideration of these factors, the tangent intersection angle of each fin is preferably greater than 0° and smaller than or equal to +60° (hereinafter referred to as optimum angle range). Therefore, in the wavelength conversion element 61C in the present embodiment, the radius of curvature of each of the fins 69 changes with the position thereon, in detail, the radius of curvature increases with distance from the side facing the center of rotation C toward the outer circumference, so that the tangent intersection angle is set at +30° over the entire length of the fin 69.

In the wavelength conversion element 61C, the fins 69 are so formed that the channel width S between the fins 69 falls within the adequate channel width range described above. The wavelength conversion element 61C can therefore be configured to provide the effects provided by the first and second embodiments described above. The wavelength conversion element 61C is, however, not necessarily configured as described above and may be so configured that the channel width S between the fins 69 does not fall within the adequate channel width range described above.

### Effects of Fourth Embodiment

The projector according to the present embodiment described above can provide the following effects as well as the same effects as those provided by the projectors shown in the first and second embodiments described above.

Since the tangent intersection angle of each of the fins 69 is so set as to fall within the adequate angle range described above, the vortex VT described above is likely to be produced between two fins 69 adjacent to each other in the +D direction in the wavelength conversion element 61C when the wavelength conversion element 61C is rotated. The vortex VT collides with the facing end surfaces of the two fins 69 that sandwich the vortex VT, whereby the heat transfer from the fins 69 to the cooling gas can be facilitated. The efficiency of cooling of the fins 69, to which the heat generated in the phosphor layer 63 is transferred via the substrate 62, and hence the efficiency of cooling of the wavelength conversion element 61C can therefore be improved. The life of the wavelength conversion element 61C can therefore be prolonged.

Each of the fins 69 has a radius of curvature that changes with the position thereon. As a result, the above-mentioned tangent intersection angle of part or entirety of each of the fins 69 is readily so set as to fall within the adequate angle range described above (optimum angle range, in particular). Therefore, in a portion where the tangent intersection angle falls within the adequate angle range described above, the vortices VT described above can be readily produced between the fins 69, whereby improvement in the efficiency of cooling of the wavelength conversion element 61C and extension of the life of the wavelength conversion element 61C can be reliably achieved.

Each of the fins 69 is formed in an arcuate shape having a radius of curvature that increases with distance from the side facing the center of rotation C toward the outer circumference. The above-mentioned tangent intersection angle over the entire length of each of the fins 69 can therefore be readily so set as to fall within the adequate angle range described above (optimum angle range, in particular). Therefore, since the vortices VT described above can be readily produced over the entire spaces between the fins 69, improvement in the efficiency of cooling of the wavelength conversion element 61C and extension of the life of the wavelength conversion element 61C can be more reliably achieved than in a case where the vortices VT described above are produced in part of the spaces between the fins 69.

The adequate angle range is a range greater than or equal to −45° and smaller than or equal to +60°. Therefore, since the fins 69 can face in the +D direction, the vortices VT described above can be more readily produced on the −D-direction side of the fins 69 when the wavelength conversion element 61C rotates. The improvement in the efficiency of cooling of the wavelength conversion element 61C and the extension of the life of the wavelength conversion element 61C can therefore be further reliably achieved.

In the case where the above-mentioned tangent intersection angle of each of the fins 69 is 0°, that is, in the case where the fins radially extend from the side facing the center of rotation C, the load acting on the rotating device 60 increases because the fins are perpendicular to the +D direction and the rotational resistance therefore increases, as described above.

On the other hand, a fin having the tangent intersection angle described above greater than or equal to −45° and smaller than 0° has a shape that warps toward the +D-direction side with distance from the side facing the center of rotation C of the substrate 62 toward the outer circumference thereof. When the fins each have the shape described above, and the wavelength conversion element described above is rotated, pressure that causes the cooling gas to flow from the side facing the outer circumference toward the center of rotation C is produced. In this case, the cooling gas flowing from the side facing the center of rotation C toward the outer circumference is likely to stay between the fins, and the efficiency of cooling the wavelength conversion element therefore decreases.

In contrast, when the fins 69 are so formed that the tangent intersection angle described above falls within the optimum angle range greater than 0° and smaller than or equal to +60°, the cooling gas flowing through the spaces between the fins 69 is likely to flow from the side facing the center of rotation C toward the outer circumference, whereby the flow speed and flow rate of the cooling gas can be increased. Therefore, since the situation in which the cooling gas to which the heat is transferred from the fins 69 stays in the spaces between the fins 69 can be avoided, the efficiency of cooling of the wavelength conversion element 61C can be further improved.

### Variations of Embodiments

The invention is not limited to the embodiments described above, and changes, improvements, and other modifications to the extent that the advantages described above can be achieved fall within the scope of the invention.

In the embodiments described above, the dimension between the fins 66 to 69 along the +D direction, that is, the width of the channel (channel width S), along which the cooling gas flowing through the spaces between the fins 66 to 69 flows, in the direction perpendicular, in a plan view, to the extension direction of the channel is so set as to fall within the adequate channel width range described above across the fins 66 to 69, but not necessarily. The channel width of only part of the channel formed between the fins may be so set as to fall within the adequate channel width range described above. For example, the channel width S may be so set as to fall within the adequate channel width range only in the portion corresponding to the outer circumferential area 62A2, or the channel width S may be so set as to fall within the adequate channel width range only in the portion corresponding to the inner circumferential area 62A1, as described above.

In the embodiments described above, the adequate channel width range, which is an index used to set the inter-fin channel width S, is set in accordance with the size of vortices produced in the spaces between the fins when the wavelength conversion element as the optical element is rotated, but not necessarily. The range of the channel width S may instead be set on the basis of any other factor.

In the embodiments described above, the adequate channel width range described above is greater than or equal to 3 mm and smaller than or equal to 6 mm. In the invention, however, the adequate channel width range is not necessarily set as described above. For example, a range different from the range described above may be used as the adequate channel width range depending on the rotational speed of the wavelength conversion element, and the inter-fin channel width S may be set in accordance with the adequate channel width range having the different value.

Further, the standing dimension of the fins 66 to 69 measured from the substrate 62 is set at 3 mm or greater, but not necessarily, and the standing dimension may be smaller than 3 mm.

In the third embodiment described above, the fins 68 includes the plurality of first fins 681, which are arranged along the rotational direction of the substrate 62, and the plurality of second fins 682, which are located between the plurality of first fins 681 and arranged along the rotational direction, and the second fins 682 are smaller than the first fins 681, but not necessarily. Third fins that are sized differently from the first and second fins may further be provided.

Further, the above-mentioned thickness dimension of the second fins 682 increases with distance from the side facing the center of rotation C toward the outer circumference, but not necessarily. The thickness dimension of the second fins 682 may be fixed, but the thickness dimension of the first fins 681 may instead increase with distance from the side facing the center of rotation C toward the outer circumference. That is, the thickness dimensions of the fins are adjustable in accordance with the inter-fin channel width S.

In the fourth embodiment described above, the tangent intersection angle described above is so set as to fall within the adequate angle range described above (optimum angle range, in particular) across the fins 69, but not necessarily. The fins 69 may be so formed that only the tangent intersection angle of part of the fins 69 is so set as to fall within the adequate angle range. For example, only the tangent intersection angle in the portion of the fins corresponding to the outer circumferential area 62A2 described above may be so set as to fall within the adequate angle range, and the tangent intersection angle in the other portion may be so set as not to fall within the adequate angle range. Conversely, only the tangent intersection angle in the portion of the fins corresponding to the inner circumferential area 62A1 described above may be so set as to fall within the adequate angle range, and the tangent intersection angle in the other portion may be so set not as to fall within the adequate angle range.

In the fourth embodiment described above, the radius of curvature of each of the fins 69 increases with distance from the side facing the center of rotation C toward the outer circumference, but not necessarily. The radius of curvature only needs to be set in accordance with the position of a portion where the tangent intersection angle is so set as to fall within the adequate angle range, as described above. Further, in correspondence with the above, each of the fins 69 may not have an arcuate shape and may include a straight portion.

In the fourth embodiment described above, the adequate angle range described above is greater than or equal to −45° and smaller than or equal to +60°, but not necessarily. Another angular range may be set on the basis of a factor other than the heat transfer coefficient. The same holds true for the optimum angle range described above.

In the embodiments described above, the fins 66 to 69, which form the heat dissipater 65, are located on the surface 62B of the substrate 62, which serves as a second surface and which is opposite the light incident surface 62A of the substrate 62, which serves as a first surface, but not necessarily. The heat dissipater having a plurality of fins may be located on the light incident surface 62A or may be located on both the light incident surface 62A and the surface 62B.

In the embodiments described above, the wavelength conversion elements 61 and 61A to 61C as the optical element are each configured as a reflective wavelength conversion element that emits fluorescence produced by incidence of excitation light toward the side on which the excitation light is incident, but not necessarily. These wavelength conversion elements may each be configured as a transmissive wavelength conversion element that emits the fluorescence from the surface 62B. In this case, the transmissive wavelength conversion element can be formed by forming the substrate 62 as a light transmissive member and disposing, in place of the reflection layer 64, a wavelength selective reflection layer that transmits the excitation light but reflects the fluorescence on the side opposite the phosphor layer 63 with respect to the substrate 62.

Further, the phosphor layer 63 and the reflection layer 64 are annually disposed around the center of rotation C, but not necessarily. At least the phosphor layer 63 may be formed in a circular shape around the center of rotation C.

In the embodiments described above, the image projection apparatus 4 has the configuration shown in FIG. 2 described above, and the illuminator 41 and the light source apparatus 5 have the configurations and arrangements shown in FIG. 3 described above, but not necessarily. The configurations and arrangements of the image projection apparatus, the illuminator, and the light source apparatus may be changed as appropriate. For example, the light source apparatus 5 may not be so configured that part of the excitation light outputted from the light source section 51 is diffusively reflected off the diffuser 58 and the other part of the excitation light is incident on the wavelength converter 6 for generation of fluorescence, followed by combination of the excitation light and the fluorescence with each other and output of the combined light. Specifically, the light source apparatus may include a wavelength converter 6 that outputs light containing blue light and the fluorescence. Still instead, the light source apparatus may have a configuration in which a light source section that outputs blue light to be combined with the fluorescence produced in the wavelength converter is provided separately from the light source section described above. Still further instead, the light outputted from the light source apparatus is not necessarily white light.

In the embodiments described above, the projector includes the three light modulators 44 (44R, 44G, and 44B) each including a liquid crystal panel, but not necessarily. The invention may be applied to a projector including two or fewer light modulators or four or greater light modulators.

In the embodiments described above, the projector includes the light modulators 44 each including a transmissive liquid crystal panel having a light incident surface and a light exiting surface separately from each other, but not necessarily. A light modulator including a reflective liquid crystal panel having a single surface that serves as both the light incident surface and the light exiting surface may be employed. Further, a light modulator using any component other than a liquid-crystal-based component and capable of modulating an incident light flux to form an image according to image information, such as a device using micromirrors, for example, a DMD (digital micromirror device), may be employed.

In the embodiments described above, the light source apparatus 5 is used in a projector by way of example, but not necessarily. The light source apparatus 5 may be used in an electronic apparatus, such as a lighting apparatus.

Further, the wavelength conversion elements 61, 61A, 61B, and 61C are presented as the optical element, but not necessarily. The configuration according to any of the embodiments of the invention may be applied to the diffusive reflection element 581.

The present application claim priority from Japanese Patent Application No. 2016-110427 filed on Jun. 1, 2016, and No. 2016-110428 filed on Jun. 1, 2016, which is hereby incorporated by reference in its entirety.

What is claimed is:

1. A light source apparatus comprising:
a light source;
an optical element on which light emitted from the light source is incident; and
a rotating device that rotates the optical element,
wherein the optical element includes
a substrate rotated by the rotating device,
an optical element layer located on a first surface of the substrate and disposed inside an outer edge of the substrate and along a rotational direction of the substrate, with the light emitted from the light source being incident on the first surface, and
a heat dissipater located on at least one of the first surface and a second surface opposite the first surface,
wherein the heat dissipater has a plurality of fins extending from a side facing a center of rotation of the optical element toward an outer circumference of the optical element and arranged along the rotational direction, and
among the plurality of fins, a dimension along the rotational direction between two fins adjacent to each other in the rotational direction is so set as to fall within a predetermined dimension range.

2. The light source apparatus according to claim 1, wherein the dimension along the rotational direction between the adjacent two fins is so set as to fall within the dimension range at least in a portion on a side facing the outer circumference of the optical element layer.

3. The light source apparatus according to claim 1, wherein the dimension along the rotational direction between the adjacent two fins is so set as to fall within the dimension range over a range from the center of rotation to an outer circumference of the substrate.

4. The light source apparatus according to claim 1, wherein the dimension range is set in accordance with a size of vortices of a cooling gas that are formed by the plurality of fins when the optical element rotates.

5. The light source apparatus according to claim 1, wherein the dimension range is greater than or equal to 3 mm and smaller than or equal to 6 mm.

6. The light source apparatus according to claim 5, wherein a dimension of the plurality of fins in a direction along an axis of rotation of the optical element is at least 3 mm.

7. The light source apparatus according to claim 1,
wherein the plurality of fins include
a plurality of first fins arranged along the rotational direction, and
a plurality of second fins that are each disposed between two first fins adjacent to each other among the plurality of first fins and are arranged along the rotational direction,
an end of each of the plurality of first fins that faces the center of rotation is located on a first virtual circle a center of which coincides with the center of rotation and which has a predetermined diameter,
an end of each of the plurality of first fins that faces the outer circumference is located on a second virtual circle a center of which coincides with the center of rotation and which has a diameter greater than the diameter of the first virtual circle,
an end of each of the plurality of second fins that faces the center of rotation is located on a third virtual circle a center of which coincides with the center of rotation and which has a diameter greater than the diameter of the first virtual circle and smaller than the diameter of the second virtual circle,
an end of each of the plurality of second fins that faces the outer circumference is located on the second virtual circle, and
among the plurality of first fins and the plurality of second fins, a dimension along the rotational direction between a first fin and a second fins adjacent to each other in the rotational direction is so set as to fall within the dimension range.

8. The light source apparatus according to claim 1, wherein an intersection angle between a line tangent to an edge of each of the fins that faces in the rotational direction and a radial direction originating from the center of rotation is so set as to fall within an angular range greater than or equal to −45° and smaller than or equal to +60°.

9. A light source apparatus comprising:
a light source;
an optical element on which light emitted from the light source is incident; and
a rotating device that rotates the optical element,
wherein the optical element includes
a substrate rotated by the rotating device,
an optical element layer located on a first surface of the substrate and disposed inside an outer edge of the substrate and along a rotational direction of the substrate, with the light emitted from the light source being incident on the first surface, and
a heat dissipater located on at least one of the first surface and a second surface opposite the first surface,
wherein the heat dissipater has a plurality of fins extending from a side facing a center of rotation of the optical element toward an outer circumference of the optical element and arranged along the rotational direction, and
an intersection angle between a line tangent to an edge of each of the plurality fins that faces opposite the rotational direction and a radial direction originating from the center of rotation is so set as to fall within a predetermined angular range.

10. The light source apparatus according to claim 9, wherein each of the plurality of fins has a radius of curvature that changes with a position thereon.

11. The light source apparatus according to claim 10, wherein each of the plurality of fins is formed in an arcuate shape having the radius of curvature that increases with distance from the side facing the center of rotation toward the outer circumference.

12. The light source apparatus according to claim 9, wherein the angular range is greater than or equal to −45° and smaller than or equal to +60°.

13. The light source apparatus according to claim 12, wherein 12, wherein the angular range is greater than 0° and smaller than or equal to +60°.

14. The light source apparatus according to claim 9, wherein among the plurality of fins, a dimension along the rotational direction between two fins adjacent to each other in the rotational direction is so set as to fall within a predetermined dimension range.

15. The light source apparatus according to claim 14, wherein the dimension range is greater than or equal to 3 mm and smaller than or equal to 6 mm.

16. A projector comprising:
the light source apparatus according to claim 1;
a light modulator that modulates light outputted from the light source apparatus; and
a projection optical apparatus that projects the light modulated by the light modulator.

17. A projector comprising:
the light source apparatus according to claim 2;
a light modulator that modulates light outputted from the light source apparatus; and
a projection optical apparatus that projects the light modulated by the light modulator.

18. A projector comprising:
the light source apparatus according to claim 3;
a light modulator that modulates light outputted from the light source apparatus; and
a projection optical apparatus that projects the light modulated by the light modulator.

19. A projector comprising:
the light source apparatus according to claim 9;
a light modulator that modulates light outputted from the light source apparatus; and
a projection optical apparatus that projects the light modulated by the light modulator.

20. A projector comprising:
the light source apparatus according to claim 10;
a light modulator that modulates light outputted from the light source apparatus; and
a projection optical apparatus that projects the light modulated by the light modulator.
